(19) United States
(12) Patent Application Publication
(10) Pub. No.: US 2021/0405328 A1
(43) Pub. Date: Dec. 30, 2021

(54) OPTICAL IMAGING SYSTEM, LENS, AND ELECTRONIC DEVICE

(71) Applicant: JIANGXI JINGCHAO OPTICAL CO., LTD., Nanchang (CN)

(72) Inventors: Xuwen DANG, Nanchang (CN); Binbin LIU, Nanchang (CN); Ming LI, Nanchang (CN); Hairong ZOU, Nanchang (CN)

(21) Appl. No.: 17/459,059

(22) Filed: Aug. 27, 2021

Related U.S. Application Data
(63) Continuation of application No. PCT/CN2020/085163, filed on Apr. 16, 2020.

(51) Int. Cl. G02B 13/00; G02B 9/60

(52) U.S. Cl. CPC G02B 13/0045; G02B 9/60

(57) ABSTRACT

An optical imaging system is provided. The optical imaging system includes, in order from an object side to an image side along an optical axis: the first lens, the second lens, the third lens, the fourth lens, and the fifth lens. The optical imaging system satisfies the following expression: 0.5<(|SAG51|+SAG52)/CT5<3.5, where SAG51 represents a distance from an intersection of the object-side surface of the fifth lens and the optical axis to a projection of an edge of an optical effective area of the object-side surface of the fifth lens on the optical axis, SAG52 represents a distance from an intersection of the image-side surface of the fifth lens and the optical axis to a projection of an edge of an optical effective area of the image-side surface of the fifth lens on the optical axis, and CT5 represents a center thickness of the fifth lens on the optical axis.

### CROSS-REFERENCE TO RELATED APPLICATION (S)

This application is a continuation of International Application No. PCT/CN2020/085163, filed on Apr. 16, 2020, the disclosure of which is hereby incorporated by reference in its entirety.

### TECHNICAL FIELD

The present applicant relates to the field of optical imaging, and in particular to an optical imaging system, a lens, and an electronic device.

### BACKGROUND

With the development of science and technology and the popularization of intelligent electronic devices, devices with image acquisition capabilities have been widely favored by people. Currently, intelligent electronic devices are becoming lighter and ultra-thin, which requires lenses in the intelligent electronic devices to be lighter and cheaper.

One camera lens usually includes multiple lenses used for optical imaging. However, an incidence angle of a chief ray of an existing lens combination on an imaging surface is large, which makes an optical imaging system of the lens combination more sensitive.

### SUMMARY

In view of this, an optical imaging system, a lens, and an electronic device are provided in the present disclosure. The optical imaging system can effectively reduce an incidence angle of a chief ray of the optical imaging system on an imaging surface, thereby reducing the sensitivity of the optical imaging system.

An optical imaging system is provided. The optical imaging system includes, in order from an object side to an image side along an optical axis: a first lens with a positive refractive power, where the first lens has an object-side surface which is convex near the optical axis; a second lens with a refractive power, where the first lens and the second lens are cemented to form a cemented lens; a third lens with a refractive power, where the third lens has an object-side surface which is convex near the optical axis and an image-side surface which is concave near the optical axis; a fourth lens with a positive refractive power, where the fourth lens has an object-side surface which is concave near the optical axis and an image-side surface which is convex near the optical axis; and a fifth lens with a refractive power, where the fifth lens has an object-side surface and an image-side surface which are aspherical, at least one of the object-side surface and the image-side surface of the fifth lens has at least one inflection point. The optical system satisfies the following expression: 0.5<(|SAG51|+SAG52)/CT5<3.5, where SAG51 represents a distance from an intersection of the object-side surface of the fifth lens and the optical axis to a projection of an edge of an optical effective area of the object-side surface of the fifth lens on the optical axis, SAG52 represents a distance from an intersection of the image-side surface of the fifth lens and the optical axis to a projection of an edge of an optical effective area of the image-side surface of the fifth lens on the optical axis, and CT5 represents a center thickness of the fifth lens on the optical axis. In this way, the fifth lens has a characteristic of satisfying 0.5<(|SAG51|+SAG52)/CT5<3.5, which can reduce the incidence angle of the chief ray of the optical imaging system on the imaging surface, thereby reducing the sensitivity of the optical imaging system. In addition, the above characteristic prevents the fifth lens from being too thin or too thick, and helps to reduce the incidence angle of the chief ray of the optical imaging system on the imaging surface, thereby reducing the sensitivity of the optical imaging system.

In some implementations, the optical imaging system satisfies the following expression: 1.0 mm⁻¹<(n1+n2)/f≤1.3 mm⁻¹, where n1 represents a refractive index of the first lens, n2 represents a refractive index of the second lens, f represents an effective focal length of the optical imaging system, and a reference wavelength of light is 587.6 nm. The first lens and the second lens are assigned with appropriate refractive powers, which can minimize the chromatic aberration and spherical aberration, and improve the imaging quality of the optical imaging system.

In some implementations, the optical imaging system satisfies the following expression: 0.8<f12/f<1.7, where f12 represents an effective focal length of the cemented lens formed by the first lens and the second lens, and f represents an effective focal length of the optical imaging system. The first lens and the second lens are cemented to form the cemented lens. When the above expression is satisfied, the optical imaging system are assigned with appropriate refractive powers. Therefore, primary spherical aberration and primary chromatic aberration can be reduced, and the resolution of the optical imaging system can be effectively improved.

In some implementations, the optical imaging system satisfies the following expression: 1.4<EPD/SD31<2.0, where EPD represents an entrance pupil diameter of the optical imaging system, and SD31 represents a maximum effective radius of the object-side surface of the third lens. When the above expression is satisfied, it means that the third lens and the first lens have similar optical apertures, so that the optical imaging system is small in size, which is beneficial to the arrangement of lenses and the compression of the size of the optical imaging system. In addition, when the above expression is satisfied, the deflection angle of light and thus the sensitivity of the optical imaging system can be reduced.

In some implementations, the optical imaging system satisfies the following expression: (|f2|+|f3|)/R31<57.0, where f2 represents an effective focal length of the second lens, f3 represents an effective focal length of the third lens, and R31 represents a radius of curvature of the object-side surface of the third lens at the optical axis. The chromatic aberration can be reduced with the cemented lens, and the refractive power can be adjusted with an appropriate cooperation between the third lens and the cemented lens, which helps to reduce the combined spherical aberration, chromatic aberration, and distortion of a lens group of the first lens, the second lens, and the third lens to an appropriate level, and reduces the difficulty of designing the fourth lens and the fifth lens. In addition, when the third lens is assigned with an appropriate radius of curvature, the surface profile will not be too complicated, which is beneficial to the forming and manufacturing of the lens.

In some implementations, the optical imaging system satisfies the following expression: f/|f3|<0.70, where f represents an effective focal length of the optical imaging system, and f3 represents an effective focal length of the third lens. The third lens is assigned with an appropriate refractive power, which facilitates a gradual diffusion of light and avoids the fourth lens and the fifth lens to make the deflection angle of light too large. In addition, when the above expression is satisfied, the aberration caused by the third lens can be significantly reduced, thereby improving the imaging quality and reducing the assembly sensitivity of the optical imaging system.

In some implementations, the optical imaging system satisfies the following expression: 6<(f1+|f2|+|f3|)/f<46.0, where f1 represents an effective focal length of the first lens, f2 represents an effective focal length of the second lens, f3 represents an effective focal length of the third lens, and f represents an effective focal length of the optical imaging system. By configuring the first lens, the second lens, and the third lens with appropriate sizes and refractive powers, a large spherical aberration caused by the lens group of the first lens, the second lens, and the third lens can be avoided, which can improve the overall resolution of the optical imaging system. In addition, when the above expression is satisfied, the sizes of the first lens, the second lens, and the third lens can be reduced, which helps to realize a miniaturized optical imaging system.

In some implementations, the optical imaging system satisfies the following expression: |R41/R51|<4.0, where R41 represents a radius of curvature of the object-side surface of the fourth lens at the optical axis, and R51 represents a radius of curvature of the object-side surface of the fifth lens at the optical axis. The positive refractive power of the fourth lens will increase the spherical aberration of the optical imaging system. By setting multiple inflection points on the object-side surface and/or image-side surface of the fifth lens, the fifth lens can be assigned with an appropriate refractive power perpendicular to the optical axis, and the overall aberration of the optical lenses can be controlled appropriately, which helps to reduce the size of a dispersion spot.

In some implementations, the optical imaging system satisfies the following expression: 1.2≤|R41|/f4<2.9, where R41 represents a radius of curvature of the object-side surface of the fourth lens at the optical axis, and f4 represents an effective focal length of the fourth lens. With the appropriate setting of the refractive power and the radius of curvature of the fourth lens, the complexity of the surface profile of the fourth lens can be reduced, and thus the increase in field curvature and distortion in the tangential direction can be suppressed to a certain extent. The reduce of the complexity of the surface profile of the fourth lens also helps to reduce the difficulty of forming the lenses and improve the overall image quality of the optical imaging system.

In some implementations, the optical imaging system satisfies the following expression: 3.0<TTL<4.0, where the optical imaging system has an imaging surface on the image side, and TTL represents a distance from the object-side surface of the first lens to the imaging surface of the optical imaging system. The total optical length of the optical imaging system can be controlled by controlling the value of TTL. When the value of TTL is reduced, the total optical length and thus the size of the optical imaging system is reduced, which makes the optical imaging system more light, thin, and miniaturized.

In some implementations, the optical imaging system satisfies the following expression: n1>1.535, where n1 represents a refractive index of the first lens, and a reference wavelength of light is 587.6 nm. The first lens introduces light into the optical imaging system, the refractive index of the first lens affects the deflection angle of the light passing through the first lens, and the deflection angle in turn affects the guiding of the light by other lenses. The material with high refractive index can reduce the deflection angle of light passing through the first lens, which helps to guide the light with the rear lenses, thereby affecting the image quality of the entire optical imaging system.

In some implementations, the optical imaging system satisfies the following expression: 70°≤FOV≤85°, where FOV represents a maximum angle of view of the optical imaging system. By controlling the maximum angle of view of the optical imaging system within a reasonable range, the optical imaging system can have a better aberration balance ability and the distortion of the optical imaging system can be controlled.

A lens is provided. The lens includes the optical imaging system above and a photosensitive element disposed on the image side of the optical imaging system. The lens of the present disclosure can reduce the incidence angle of the chief ray of the optical imaging system on the imaging surface, thereby reducing the sensitivity of the optical imaging system. In addition, the above characteristic prevents the fifth lens from being too thin or too thick, and helps to reduce the incidence angle of the chief ray of the optical imaging system on the imaging surface, thereby reducing the sensitivity of the optical imaging system.

An electronic device is provided. The electronic device includes a main body and the lens above installed on the main body. The electronic device of the present disclosure can reduce the incidence angle of the chief ray of the optical imaging system on the imaging surface, thereby reducing the sensitivity of the optical imaging system. In addition, the above characteristic prevents the fifth lens from being too thin or too thick, and helps to reduce the incidence angle of the chief ray of the optical imaging system on the imaging surface, thereby reducing the sensitivity of the optical imaging system.

In conclusion, with the fifth lens satisfying 0.5<(|SAG51|+SAG52)/CT5<3.5, according to the present disclosure, the incidence angle of the chief ray of the optical imaging system on the imaging surface can be reduced, thereby reducing the sensitivity of the optical imaging system. In addition, the above characteristic prevents the fifth lens from being too thin or too thick, and helps to reduce the incidence angle of the chief ray of the optical imaging system on the imaging surface, thereby reducing the sensitivity of the optical imaging system.

### BRIEF DESCRIPTION OF THE DRAWINGS

In order to more clearly describe the technical solutions in the implementations of the present disclosure or the related art, the following will briefly introduce the drawings that need to be used in the description of the implementations or the related art. Obviously, the drawings in the following description illustrate only some implementations of the present disclosure. For those of ordinary skill in the art, other drawings can be obtained based on these drawings without creative work.

FIG. 1 is a schematic structural diagram of an optical imaging system according to an implementation of the present disclosure.

FIG. 2A to FIG. 2C respectively show the spherical aberration curve, the astigmatic field curve, and the distortion curve of the optical imaging system of FIG. 1.

FIG. 3 is a schematic structural diagram of an optical imaging system according to an implementation of the present disclosure.

FIG. 4A to FIG. 4C respectively show the spherical aberration curve, the astigmatic field curve, and the distortion curve of the optical imaging system of FIG. 3.

FIG. 5 is a schematic structural diagram of an optical imaging system according to an implementation of the present disclosure.

FIG. 6A to FIG. 6C respectively show the spherical aberration curve, the astigmatic field curve, and the distortion curve of the optical imaging system of FIG. 5.

FIG. 7 is a schematic structural diagram of an optical imaging system according to an implementation of the present disclosure.

FIG. 8A to FIG. 8C respectively show the spherical aberration curve, the astigmatic field curve, and the distortion curve of the optical imaging system of FIG. 7.

FIG. 9 is a schematic structural diagram of an optical imaging system according to an implementation of the present disclosure.

FIG. 10A to FIG. 10C respectively show the spherical aberration curve, the astigmatic field curve, and the distortion curve of the optical imaging system of FIG. 9.

FIG. 11 is a schematic structural diagram of an optical imaging system according to an implementation of the present disclosure.

FIG. 12A to FIG. 12C respectively show the spherical aberration curve, the astigmatic field curve, and the distortion curve of the optical imaging system of FIG. 11.

FIG. 13 is a schematic structural diagram of an optical imaging system according to an implementation of the present disclosure.

FIG. 14A to FIG. 14C respectively show the spherical aberration curve, the astigmatic field curve, and the distortion curve of the optical imaging system of FIG. 13.

### DETAILED DESCRIPTION

The technical solutions in the implementations of the present disclosure will be clearly and completely described below in conjunction with the drawings in the implementations of the present disclosure. Obviously, the described implementations are merely a part rather than all of the implementations of the present disclosure. Based on the implementations in this disclosure, all other implementations obtained by those of ordinary skill in the art without creative work shall fall within the protection scope of this disclosure.

In some implementations of the present disclosure, an optical imaging system is provided, which helps to reduce the incidence angle of the chief ray of the optical imaging system on the imaging surface, thereby reducing the sensitivity of the optical imaging system.

The optical imaging system is introduced as follows.

The optical imaging system has an object side and an image side, and there is an imaging surface on the image side. The optical imaging system includes, in order from the object side to the image side along an optical axis: a first lens with a positive refractive power, where the first lens has an object-side surface which is convex near the optical axis; a second lens with a refractive power, where the first lens and the second lens are cemented to form a cemented lens; a third lens with a refractive power, where the third lens has an object-side surface which is convex near the optical axis and an image-side surface which is concave near the optical axis; a fourth lens with a positive refractive power, where the fourth lens has an object-side surface which is concave near the optical axis and an image-side surface which is convex near the optical axis; and a fifth lens with a refractive power, where the fifth lens has an object-side surface and an image-side surface which are aspherical, at least one of the object-side surface and the image-side surface of the fifth lens has at least one inflection point. The optical system satisfies the following expression: 0.5<(|SAG51|+SAG52)/CT5<3.5, where SAG51 represents a distance from an intersection of the object-side surface of the fifth lens and the optical axis to a projection of an edge of an optical effective area of the object-side surface of the fifth lens on the optical axis, SAG52 represents a distance from an intersection of the image-side surface of the fifth lens and the optical axis to a projection of an edge of an optical effective area of the image-side surface of the fifth lens on the optical axis, and CT5 represents a center thickness of the fifth lens on the optical axis.

The fifth lens has a characteristic of satisfying 0.5<(|SAG51|+SAG52)/CT5<3.5, which can reduce the incidence angle of the chief ray of the optical imaging system on the imaging surface, thereby reducing the sensitivity of the optical imaging system. In addition, the above characteristic prevents the fifth lens from being too thin or too thick, and helps to reduce the incidence angle of the chief ray of the optical imaging system on the imaging surface, thereby reducing the sensitivity of the optical imaging system.

(|SAG51|+SAG52)/CT5 may have a value such as 0.6, 3.4, 0.55, 3.45, 0.7, 3.3, or another value that satisfies 0.5<(|SAG51|+SAG52)/CT5<3.5.

In some examples, at least one of the object-side surface and the image-side surface of the fifth lens has at least one inflection point. When the fifth lens has multiple inflection points, it is beneficial to the correction of the distortion and field curvature caused by the optical imaging system, so that the refractive power near the imaging surface of the optical imaging system is configured more uniform.

In the present disclosure, the first lens has an object-side surface near the object side and an image-side surface near the image side. The second lens has an object-side surface near the object side and an image-side surface near the image side. The third lens has an object-side surface near the object side and an image-side surface near the image side. The fourth lens has an object-side surface near the object side and an image-side surface near the image side. In the optical imaging system, the first lens and the second lens are cemented to form a cemented lens. The third lens, the fourth lens, and the fifth lens may be independent of each other with air gaps therebetween. The introduction of the cemented lens helps to eliminate the chromatic aberration of each lens in the cemented lens, and can also leave some chromatic aberration to balance the chromatic aberration of the optical imaging system, thereby enhancing the ability of the optical imaging system to balance chromatic aberration and improving imaging resolution. In addition, the cementing of the first lens and the second lens omits the air gap therebetween, which makes the overall structure of the optical imaging system compact and simple and helps to reduce the total optical length of the optical imaging system and meet the requirements of miniaturization. In addition, the cementing of the lenses will reduce tolerance sensitivity issues such as tilt or eccentricity of each lens in the assembly process. In the assembly process, the cemented lens has a better coaxiality than separate lenses, thereby improving the yield of the assembly process.

In some implementations, the first lens has a positive refractive power, and the object-side surface of the first lens is convex. The second lens has a refractive power. The third lens has a refractive power, the object-side surface of the third lens is convex, and the image-side surface of the third lens is concave. The fourth lens has a positive refractive power, the object-side surface of the fourth lens is concave near the optical axis, and the image-side surface of the fourth lens is convex at the optical axis. Being near the optical axis refers to being in a region near the optical axis. In some implementations, the optical imaging system satisfies the following expression: 1.0 mm⁻¹<(n1+n2)/f≤1.3 mm⁻¹, where n1 represents a refractive index of the first lens, n2 represents a refractive index of the second lens, f represents an effective focal length of the optical imaging system, and a reference wavelength of light is 587.6 nm. The first lens and the second lens are assigned with appropriate refractive powers, which can minimize the chromatic aberration and spherical aberration, and improve the imaging quality of the optical imaging system.

In some implementations, the optical imaging system satisfies the following expression: 0.8<f12/f<1.7, where f12 represents an effective focal length of the cemented lens formed by the first lens and the second lens, and f represents an effective focal length of the optical imaging system. The first lens and the second lens are cemented to form the cemented lens. When the above expression is satisfied, the optical imaging system are assigned with appropriate refractive powers. Therefore, primary spherical aberration and primary chromatic aberration can be reduced, and the resolution of the optical imaging system can be effectively improved.

In some implementations, the optical imaging system satisfies the following expression: 1.4<EPD/SD31<2.0, where EPD represents an entrance pupil diameter of the optical imaging system, and SD31 represents a maximum effective radius of the object-side surface of the third lens. The effective radius may be the maximum effective radius of the object-side surface of the third lens. When the above expression is satisfied, it means that the third lens and the first lens have similar optical apertures, so that the optical imaging system is small in size, which is beneficial to the arrangement of lenses and the compression of the size of the optical imaging system. In addition, when the above expression is satisfied, the deflection angle of light and thus the sensitivity of the optical imaging system can be reduced.

In some implementations, the optical imaging system satisfies the following expression: (|f2|+|f3|)/R31<57.0, where f2 represents an effective focal length of the second lens, f3 represents an effective focal length of the third lens, and R31 represents a radius of curvature of the object-side surface of the third lens near the optical axis. The chromatic aberration can be reduced with the cemented lens, and the refractive power can be adjusted with an appropriate cooperation between the third lens and the cemented lens, which helps to reduce the combined spherical aberration, chromatic aberration, and distortion of a lens group of the first lens, the second lens, and the third lens to an appropriate level, and reduces the difficulty of designing the fourth lens and the fifth lens. In addition, when the third lens is assigned with an appropriate radius of curvature, the surface profile will not be too complicated, which is beneficial to the forming and manufacturing of the lens.

In some implementations, the optical imaging system satisfies the following expression: f/|f3|<0.70, where f represents an effective focal length of the optical imaging system, and f3 represents an effective focal length of the third lens. The third lens is assigned with an appropriate refractive power, which facilitates a gradual diffusion of light and avoids the fourth lens and the fifth lens to make the deflection angle of light too large. In addition, when the above expression is satisfied, the aberration caused by the third lens can be significantly reduced, thereby improving the imaging quality and reducing the assembly sensitivity of the optical imaging system.

In some implementations, the optical imaging system satisfies the following expression: 6<(f1+|f2|+|f3|)/f<46.0, where f2 represents an effective focal length of the first lens, f2 represents an effective focal length of the second lens, f3 represents an effective focal length of the third lens, and f represents an effective focal length of the optical imaging system. By configuring the first lens, the second lens, and the third lens with appropriate sizes and refractive powers, a large spherical aberration caused by the lens group of the first lens, the second lens, and the third lens can be avoided, which can improve the overall resolution of the optical imaging system. In addition, when the above expression is satisfied, the sizes of the first lens, the second lens, and the third lens can be reduced, which helps to realize a miniaturized optical imaging system.

In some implementations, the optical imaging system satisfies the following expression: |R41/R51|<4.0, where R41 represents a radius of curvature of the object-side surface of the fourth lens near the optical axis, and R51 represents a radius of curvature of the object-side surface of the fifth lens near the optical axis. The positive refractive power of the fourth lens will increase the spherical aberration of the optical imaging system. By setting multiple inflection points on the object-side surface and/or image-side surface of the fifth lens, the fifth lens can be assigned with an appropriate refractive power perpendicular to the optical axis, and the overall aberration of the optical lenses can be controlled appropriately, which helps to reduce the size of a dispersion spot.

In some implementations, the optical imaging system satisfies the following expression: 1.2≤|R41|/f4<2.9, where R41 represents a radius of curvature of the object-side surface of the fourth lens near the optical axis, and f4 represents an effective focal length of the fourth lens. With the appropriate setting of the refractive power and the radius of curvature of the fourth lens, the complexity of the surface profile of the fourth lens can be reduced, and thus the increase in field curvature and distortion in the tangential direction can be suppressed to a certain extent. The reduce of the complexity of the surface profile of the fourth lens also helps to reduce the difficulty of forming the lenses and improve the overall image quality of the optical imaging system.

In some implementations, the optical imaging system satisfies the following expression: 3.0<TTL<4.0, where TTL represents a distance from the object-side surface of the first lens to the imaging surface of the optical imaging system, that is, the total optical length. The total optical length of the optical imaging system can be controlled by controlling the value of TTL. When the value of TTL is reduced, the total optical length and thus the size of the optical imaging system is reduced, which makes the optical imaging system more light, thin, and miniaturized.

In some implementations, the optical imaging system satisfies the following expression: n1>1.535, where n1 represents a refractive index of the first lens, and a reference wavelength of light is 587.6 nm. The first lens introduces light into the optical imaging system, the refractive index of the first lens affects the deflection angle of the light passing through the first lens, and the deflection angle in turn affects the guiding of the light by other lenses. The material with high refractive index can reduce the deflection angle of light passing through the first lens, which helps to guide the light with the rear lenses, thereby affecting the image quality of the entire optical imaging system.

In some implementations, the optical imaging system satisfies the following expression: 70°≤FOV≤85°, where FOV represents a maximum angle of view of the optical imaging system. In some examples, the angle of view is of a field of view of 1.0, that is, a maximum angle of view. By controlling the maximum angle of view of the optical imaging system within a reasonable range, the optical imaging system can have a better aberration balance ability and the distortion of the optical imaging system can be controlled.

In some examples, at least one of the mirror surfaces of each lens is an aspherical mirror surface. That is, at least one of the object-side surface and the image-side surface of each of the first lens, the second lens, the third lens, the fourth lens, and the fifth lens is an aspherical mirror surface. A characteristic of an aspherical lens is that the curvature changes continuously from the center of the lens to the periphery of the lens. Unlike a spherical lens with constant curvature from the center of the lens to the periphery of the lens, an aspherical lens has a better characteristic of radius of curvature and an advantage of improving the distortion, astigmatism, and aberration. With the aspherical lens, the aberration that occurs during imaging can be eliminated as much as possible, thereby improving the imaging quality. In some examples, the object-side surface and the image-side surface of each of the first lens, the second lens, the third lens, the fourth lens, and the fifth lens are aspherical mirror surfaces.

In some examples, the first lens, the second lens, the third lens, the fourth lens, and the fifth lens are all made of plastic. Plastic lenses are easy to manufacture with high forming efficiency and low cost, which is beneficial to large-scale mass production. On the one hand, plastic lenses are easy to manufacture. On the other hand, cemented lenses help to eliminate the chromatic aberration and have good coaxiality. Therefore, the yield of the assembly process can be significantly improved.

In some examples, the optical imaging system further includes at least one stop to improve the imaging quality of the optical imaging system. For example, a stop is disposed between the object side and the first lens.

A lens is also provided in the present disclosure. The lens includes the above optical imaging system and a photosensitive element disposed on the image side of the optical imaging system. The photosensitive element may be a charge coupled device (CCD) or a complementary metal oxide semiconductor (CMOS). The lens can achieve a good imaging effect with the design of the optical imaging system. Further, the lens may also include a lens barrel, a supporting device, or a combination thereof.

An electronic device is also provided in the present disclosure. The electronic device includes a main body and the above lens installed on the main body of the electronic device. The lens of the electronic device can achieve excellent imaging effects. The electronic device can be a portable device such as a smart phone, a digital camera, a tablet computer, a wearable device, or the like.

Specific examples of the optical imaging lens applicable to the above implementations will be further described below with reference to the accompanying drawings.

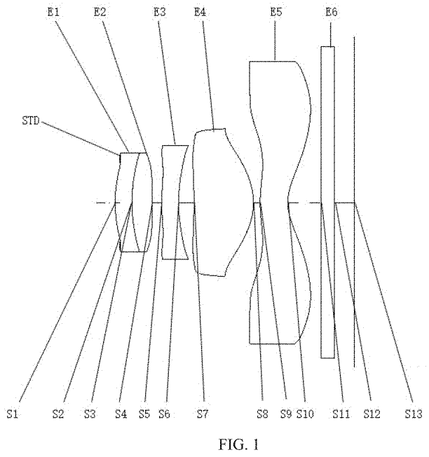

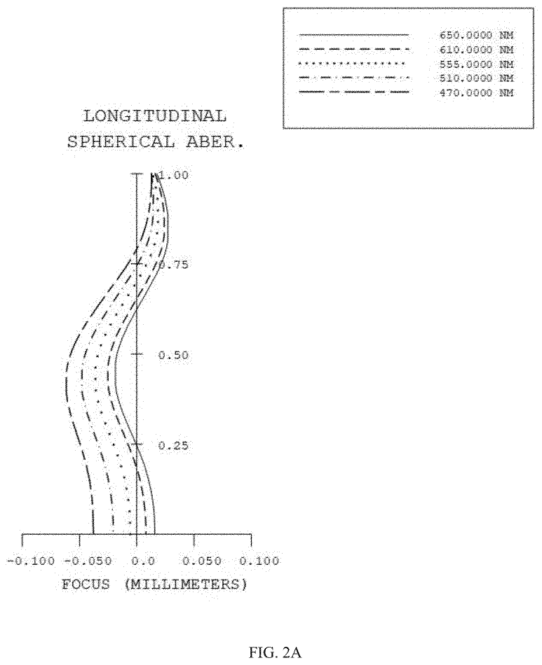

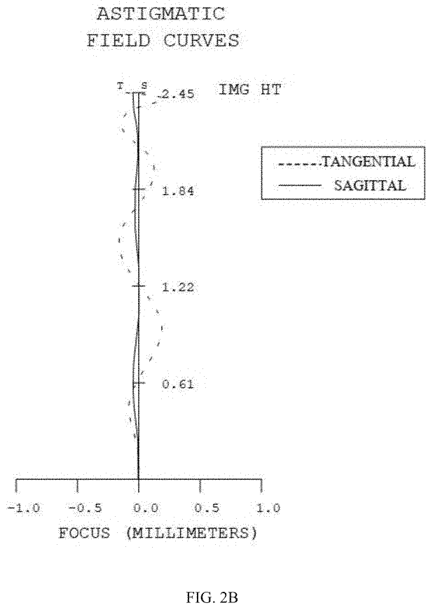

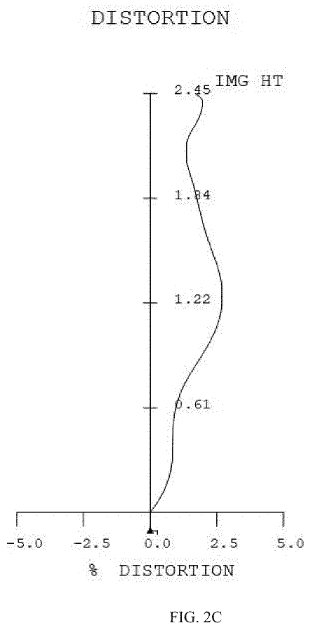

An optical imaging system according to an implementation of the present disclosure will be described below with reference to FIGS. 1 to 2C. FIG. 1 shows a schematic structural diagram of the optical imaging system according to an implementation of the present disclosure.

As shown in FIG. 1, the optical imaging system includes, in order from an object side to an image side: a stop ST0, a first lens E1, a second lens E2, a third lens E3, a fourth lens E4, a fifth lens E5, a filter E6, and an imaging surface S13.

The first lens E1 has a positive refractive power and has an object-side surface S1 which is convex near an optical axis and an image-side surface S2 which is concave near the optical axis. At the periphery, the object-side surface S1 of the first lens is convex, and the image-side surface S2 is concave. The second lens E2 has a negative refractive power and has an object-side surface S3 which is convex near the optical axis and an image-side surface S4 which is concave near the optical axis. At the periphery, the object-side surface S3 of the second lens is convex, and the image-side surface S4 is convex. The third lens E3 has a negative refractive power and has an object-side surface S5 which is convex near the optical axis and an image-side surface S6 which is concave near the optical axis. At the periphery, the object-side surface S5 of the third lens is convex, and the image-side surface S6 is concave. The fourth lens E4 has a positive refractive power and has an object-side surface S7 which is concave near the optical axis and an image-side surface S8 which is convex near the optical axis. At the periphery, the object-side surface S7 of the fourth lens is convex, and the image-side surface S8 is concave. The fifth lens E5 has a negative refractive power and has an object-side surface S9 which is convex near the optical axis and an image-side surface S10 which is concave near the optical axis. At the periphery, the object-side surface S9 of the fifth lens is concave, and the image-side surface S10 is convex. The filter E6 has an object-side surface S11 and an image-side surface S12. The light from an object sequentially passes through the surfaces S1 to S12 and is finally imaged on the imaging surface S13.

In this implementation, the image-side surface S2 of the first lens E1 is cemented with the object-side surface S3 of the second lens E2 to form a cemented lens. Any one of the third lens E3, the fourth lens E4, and the fifth lens E5 and its adjacent lens are independent of each other and have an air gap therebetween.

Table 1 shows the surface type, radius of curvature, thickness, material, refractive index, Abbe number, and effective focal length of each lens of the optical imaging system of this implementation, where the radius of curvature, thickness, and effective focal length are all in millimeters (mm).

TABLE 1
Optical imaging system of FIG. 1
f = 2.44 mm, F_{NO} = 2.09, FOV = 84.98°, TTL = 3.60 mm

| | | | | | | | | Effective |
|---|---|---|---|---|---|---|---|---|
| Surface | Surface | | Radius of | | | Refractive | Abbe | focal |
| number | name | Surface type | curvature | Thickness | Material | index | number | length |
| OBJ | Object-side | Spherical | Infinity | 400.00 | | | | |
| | surface | | | | | | | |
| STO | Stop | Spherical | Infinity | −0.071 | | | | |
| S1 | First lens | Aspherical | 1.916 | 0.254 | Plastic | 1.651 | 21.516 | 5.14 |
| S2/S3 | Second lens | Aspherical | 2.506 | 0.303 | Plastic | 1.545 | 55.912 | −17.74 |
| S4 | | Aspherical | 44.820 | 0.143 | Plastic | 1.545 | 55.912 | −17.74 |
| S5 | Third lens | Aspherical | 2.765 | 0.252 | Plastic | 1.661 | 20.412 | −13.11 |
| S6 | | Aspherical | 2.024 | 0.233 | Plastic | | | |
| S7 | Fourth lens | Aspherical | −5.651 | 0.894 | Plastic | 1.545 | 55.912 | 1.98 |
| S8 | | Aspherical | −0.956 | 0.101 | Plastic | | | |
| S9 | Fifth lens | Aspherical | 1.561 | 0.416 | Plastic | 1.545 | 55.912 | −2.43 |
| S10 | | Aspherical | 0.649 | 0.496 | Plastic | | | |
| S11 | Infrared | Spherical | Infinity | 0.210 | Glass | 1.516 | 64.048 | |
| S12 | filter | Spherical | Infinity | 0.294 | Glass | | | |
| S13 | Imaging | Spherical | Infinity | 0 | | | | |
| | surface | | | | | | | |

Note:
The reference wavelength = 555 nm.

The effective focal length of the optical imaging system in this implementation is represented as EEL, the F-number of the optical imaging system is represented as Fₙₒ, the angle of view of the optical imaging system is represented as FOV, and the total optical length of the optical imaging system is represented as TTL, and f2.44 mm, F_{NO}=2.09, F0V=84.980, TTL=3.60 mm.

It can be seen from Table 1 that the object-side surface and the image-side surface of any one of the first lens E1 to the fifth lens E5 are aspherical. In this implementation, the surface profile x of each aspherical lens can be defined by but not limited to the following aspherical formula:

$$x = \frac{{ch}^{2}}{1 + \sqrt{1 - ( k + 1 ) {c}^{2} {h}^{2}}} + \sum {Aih}^{i} ,$$

where x represents a distance (sagittal depth) along the optical axis from a vertex of the aspherical surface to a position on the aspherical surface at a height h, c represents the paraxial curvature of the aspherical surface, which is the inverse of the radius of curvature R (that is, c=1/R, where R represents the radius of curvature in the Table 1), k represents the conic coefficient, Ai represents the i-th order correction coefficient of the aspherical surface. Table 2 below shows the conic coefficient k and the higher-order coefficients A4, A6, A8, A10, A12, A14, A16, A18, and A20 of each of aspherical lens surfaces S11 to S10 in this implementation.

TABLE 2
Optical imaging system of FIG. 1

| | Surface number | | | | | | | | |
|---|---|---|---|---|---|---|---|---|---|
| | S1 | S2/S3 | S4 | S5 | S6 | S7 | S8 | S9 | S10 |
| K | 5.2253E− | 0.0000E+ | −4.1398E+ | −5.4966E+ | 2.4006E+ | 1.2270E+ | −3.7603E+ | −3.7878E+ | −3.7768E+ |
| | 01 | 00 | 01 | 00 | 00 | 01 | 00 | 01 | 00 |
| A4 | −9.5009E− | 0.0000E+ | −3.5119E− | −5.0707E− | −7.8769E− | 1.0492E+ | −4.0508E− | −1.6647E− | −2.2399E− |
| | 02 | 00 | 01 | 01 | 02 | 00 | 01 | 01 | 01 |
| A6 | 8.5876E− | 0.0000E+ | −2.9360E− | 6.8515E− | −1.7966E+ | −1.2532E+ | 1.4690E+ | −3.9959E− | 1.7506E− |
| | 01 | 00 | 01 | 01 | 00 | 01 | 00 | 01 | 01 |
| A8 | −1.3695E+ | 0.0000E+ | 3.5443E+ | −3.8499E+ | 1.1228E+ | 7.9104E+ | −5.0859E+ | 1.2318E+ | −7.8191E− |
| | 01 | 00 | 00 | 00 | 01 | 01 | 00 | 00 | 02 |
| A10 | 1.1211E+ | 0.0000E+ | −1.9527E+ | 1.4966E+ | −4.0473E+ | −2.8580E+ | 1.2269E+ | −1.6854E+ | 4.6483E− |
| | 02 | 00 | 01 | 01 | 01 | 02 | 01 | 00 | 03 |
| A12 | −5.5279E+ | 0.0000E+ | 5.8179E+ | −2.9031E+ | 9.5048E+ | 6.3094E+ | −1.8795E+ | 1.3719E+ | 1.4945E− |
| | 02 | 00 | 01 | 01 | 01 | 02 | 01 | 00 | 02 |
| A14 | 1.6764E+ | 0.0000E+ | −8.4207E+ | 3.3839E+ | −1.4359E+ | −8.6518E+ | 1.8092E+ | −6.8524E− | −8.6620E− |
| | 03 | 00 | 01 | 01 | 02 | 02 | 01 | 01 | 03 |
| A16 | −3.0779E+ | 0.0000E+ | 3.9367E+ | −2.3032E+ | 1.3401E+ | 7.1916E+ | −1.0463E+ | 2.0565E− | 2.2753E− |
| | 03 | 00 | 01 | 01 | 02 | 02 | 01 | 01 | 03 |
| A18 | 3.1482E+ | 0.0000E+ | 2.6266E+ | 6.5264E+ | −7.0005E+ | −3.3188E+ | 3.2932E+ | −3.4064E− | −2.9605E− |
| | 03 | 00 | 01 | 00 | 01 | 02 | 00 | 02 | 04 |
| A20 | −1.3811E+ | 0.0000E+ | −2.4613E+ | 2.9819E− | 1.5564E+ | 6.5256E+ | −4.3163E− | 2.3936E− | 1.5295E− |
| | 03 | 00 | 01 | 01 | 01 | 01 | 01 | 03 | 05 |

The optical imaging system in this implementation satisfies the following expression. (|SAG51|+SAG52)/CT5=1.19, where SAG51 represents a distance from an intersection of the object-side surface S9 of the fifth lens E5 and the optical axis to a projection of an edge of an optical effective area of the object-side surface S9 of the fifth lens E5 on the optical axis, SAG52 represents a distance from an intersection of the image-side surface S10 of the fifth lens E5 and the optical axis to a projection of an edge of an optical effective area of the image-side surface S10 of the fifth lens E5 on the optical axis, and CT5 represents a center thickness of the fifth lens E5 on the optical axis.

(n1+n2)/f=1.30 mm¹, where n1 represents a refractive index of the first lens E1, n2 represents a refractive index of the second lens E2, and f represents a total effective focal length of the optical imaging system.

f12/f=1.41, where f12 represents an effective focal length of the cemented lens formed by the first lens and the second lens, and f represents an effective focal length of the optical imaging system. For example, f12=3.45 mm, f2.45 mm.

EPD/SD31=1.51, where EPD represents an entrance pupil diameter of the optical imaging system, and SD31 represents a maximum effective radius of the object-side surface S5 of the third lens E3.

(|f2|+|f3|)/R31=11.18, where f2 represents an effective focal length of the second lens E2, f3 represents an effective focal length of the third lens E3, and R31 represents a radius of curvature of the object-side surface S5 of the third lens E3 near the optical axis.

f/|f3|=0.19, where f represents a total effective focal length of the optical imaging system, and f3 represents an effective focal length of the third lens E3.

(f1+|f2|+|f3|)/f=14.69, where f1 represents an effective focal length of the first lens E1, f2 represents an effective focal length of the second lens E2, f3 represents an effective focal length of the third lens E3, and f represents a total effective focal length of the optical imaging system.

|R41/R51|=3.62, where R41 represents a radius of curvature of the object-side surface S7 of the fourth lens E4 near the optical axis, and R51 represents a radius of curvature of the object-side surface S9 of the fifth lens E5 at the paraxial axis.

|R41|/f4=2.85, where R41 represents a radius of curvature of the object-side surface S7 of the fourth lens E4 near the optical axis, and f4 represents an effective focal length of the fourth lens E4.

TTL=3.60 mm, where TTL represents a distance from the object-side surface S1 of the first lens E1 to the imaging surface S13 of the optical imaging system.

n1=1.651, where n1 represents a refractive index of the first lens E1, and a reference wavelength of light is 587.6 nm.

FOV=84.98°, where FOV represents a maximum angle of view of the optical imaging system.

FIG. 2A shows the spherical aberration curve of the optical imaging system of FIG. 1, which represents the deviation in focal point of light of different wavelengths after passing through the lenses. FIG. 2B shows the astigmatic field curve of the optical imaging system of FIG. 1, which represents the tangential field curvature and the sagittal field curvature. FIG. 2C shows the distortion curve of the optical imaging system of FIG. 1, which represents the magnitude of distortion corresponding to different image heights. It can be seen from FIGS. 2A to 2C that the optical imaging system of FIG. 1 can have good imaging quality.

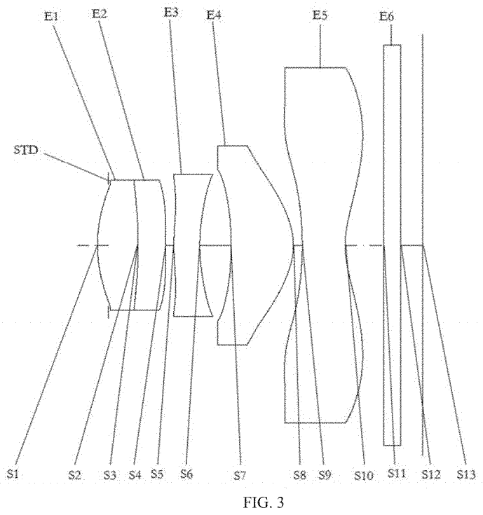

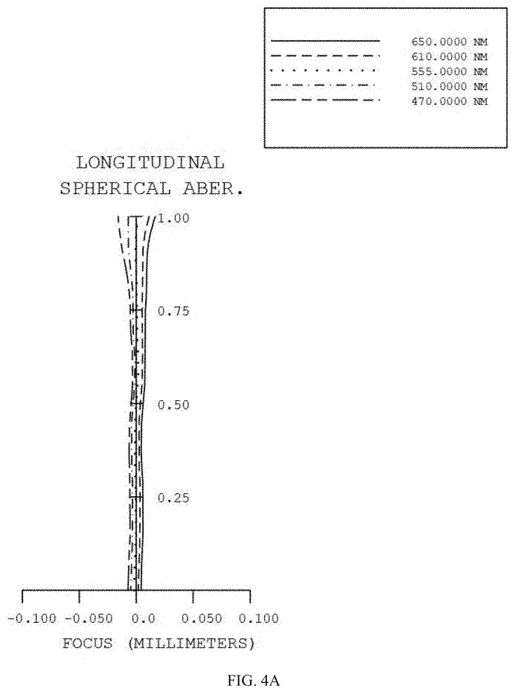

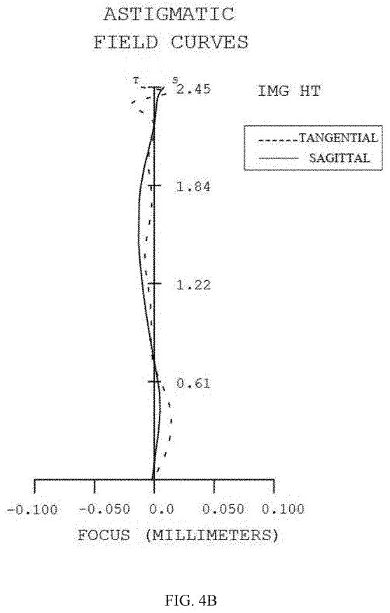

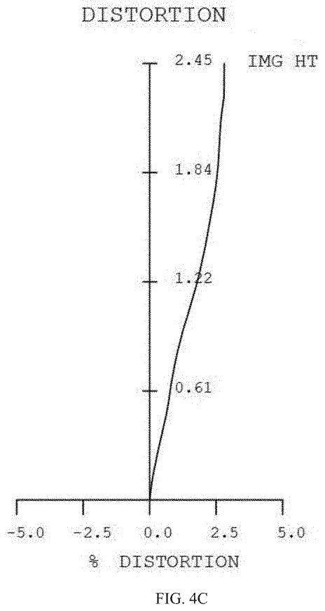

An optical imaging system according to an implementation of the present disclosure will be described below with reference to FIGS. 3 to 4C. In this implementation and the following implementations, for the sake of brevity, some descriptions similar to those in the above implementation will be omitted. FIG. 3 shows a schematic structural diagram of the optical imaging system according to an implementation of the present disclosure.

As shown in FIG. 3, the optical imaging system includes, in order from an object side to an image side: a stop ST0, a first lens E1, a second lens E2, a third lens E3, a fourth lens E4, a fifth lens E5, a filter E6, and an imaging surface S13.

The first lens E1 has a positive refractive power and has an object-side surface S1 which is convex near an optical axis and an image-side surface S2 which is convex near the optical axis. At the periphery, the object-side surface S1 of the first lens is convex, and the image-side surface S2 is convex. The second lens E2 has a negative refractive power and has an object-side surface S3 which is concave near the optical axis and an image-side surface S4 which is concave near the optical axis. At the periphery, the object-side surface S3 of the second lens is convex, and the image-side surface S4 is concave. The third lens E3 has a negative refractive power and has an object-side surface S5 which is convex near the optical axis and an image-side surface S6 which is concave near the optical axis. At the periphery, the object-side surface S5 of the third lens is concave, and the image-side surface S6 is concave. The fourth lens E4 has a positive refractive power and has an object-side surface S7 which is concave near the optical axis and an image-side surface S8 which is convex near the optical axis. At the periphery, the object-side surface S7 of the fourth lens is concave, and the image-side surface S8 is convex. The fifth lens E5 has a negative refractive power and has an object-side surface S9 which is concave near the optical axis and an image-side surface S10 which is concave near the optical axis. At the periphery, the object-side surface S9 of the fifth lens is convex, and the image-side surface S10 is convex. The filter E6 has an object-side surface S11 and an image-side surface S12. The light from an object sequentially passes through the surfaces S1 to S12 and is finally imaged on the imaging surface S13.

In this implementation, the image-side surface S2 of the first lens E is cemented with the object-side surface S3 of the second lens E2 to form a cemented lens. Any one of the third lens E3, the fourth lens E4, and the fifth lens E5 and its adjacent lens are independent of each other and have an air gap therebetween.

Table 3 shows the surface type, radius of curvature, thickness, material, refractive index, Abbe number, and effective focal length of each lens of the optical imaging system of this implementation, where the radius of curvature, thickness, and effective focal length are all in millimeters (mm).

TABLE 3
Optical imaging system of FIG. 3
f = 3.01 mm, F_{NO} = 2.15, FOV = 72.63°, TTL = 3.96 mm

| | | | | | | | | Effective |
|---|---|---|---|---|---|---|---|---|
| Surface | | Surface | Radius of | | | Refractive | Abbe | focal |
| number | Surface name | type | curvature | Thickness | Material | index | number | length |
| OBJ | Object-side | Spherical | Infinity | 400.00 | | | | |
| | surface | | | | | | | |
| STO | Stop | Spherical | Infinity | −0.135 | | | | |
| S1 | First lens | Aspherical | 1.561 | 0.495 | Plastic | 1.545 | 55.912 | 4.94 |
| S2/S3 | Second lens | Aspherical | −4.721 | 0.332 | Plastic | 1.636 | 23.972 | −17.46 |
| S4 | | Aspherical | 17.254 | 0.103 | Plastic | 1.636 | 23.972 | −17.46 |
| S5 | Third lens | Aspherical | 2.552 | 0.315 | Plastic | 1.661 | 20.412 | −16.38 |
| S6 | | Aspherical | 1.966 | 0.383 | Plastic | | | |
| S7 | Fourth lens | Aspherical | −3.315 | 0.757 | Plastic | 1.545 | 55.912 | 1.51 |
| S8 | | Aspherical | −0.713 | 0.109 | Plastic | | | |
| S9 | Fifth lens | Aspherical | −2.910 | 0.522 | Plastic | 1.545 | 55.912 | −1.35 |
| S10 | | Aspherical | 1.051 | 0.468 | Plastic | | | |
| S11 | Infrared filter | Spherical | Infinity | 0.210 | Glass | 1.516 | 64.048 | |
| S12 | | Spherical | Infinity | 0.266 | Glass | | | |
| S13 | Imaging | Spherical | Infinity | 0 | | | | |
| | surface | | | | | | | |

Note:
The reference wavelength = 555 nm.

The effective focal length of the optical imaging system in this implementation is represented as EEL, the F-number of the optical imaging system is represented as Fₙₒ, the angle of view of the optical imaging system is represented as FOV, and the total optical length of the optical imaging system is represented as TTL, and f=3.01 mm, F_{NO}=2.15, FOV=72.63 (degrees), TTL=3.96 mm.

It can be seen from Table 3 that the object-side surface and the image-side surface of any one of the first lens E1 to the fifth lens E5 are aspherical. Table 4 below shows the conic coefficient k and the higher-order coefficients A4, A6, A8, A10, A12, A14, A16, A18, and A20 of each of aspherical lens surfaces S11 to S10 in this implementation.

TABLE 4
Optical imaging system of FIG. 3

| | Surface number | | | | | | | | |
|---|---|---|---|---|---|---|---|---|---|
| | 2 | 3 | 4 | 5 | 6 | 7 | 8 | 9 | 10 |
| K | 8.3570E− | −2.9754E+ | 9.9000E+ | −1.0459E+ | 2.5244E+ | 1.2162E+ | −4.2693E+ | −7.6918E+ | −7.3082E+ |
| | 01 | 01 | 01 | 01 | 00 | 01 | 00 | 01 | 00 |
| A4 | −7.6844E− | −1.2590E− | −3.6070E− | −3.3327E− | −1.2520E− | −3.1872E− | −3.2406E− | −8.6551E− | −1.3388E− |
| | 02 | 28 | 01 | 01 | 01 | 02 | 01 | 02 | 01 |
| A6 | 3.0899E− | 3.6994E− | 1.0988E− | −7.6982E− | −3.3621E− | 3.8980E− | 6.6073E− | −6.3150E− | 1.2155E− |
| | 01 | 45 | 01 | 01 | 01 | 01 | 01 | 02 | 01 |
| A8 | −3.0245E+ | −6.7798E− | 3.4658E+ | 6.4279E+ | 1.3802E+ | −1.8475E+ | −1.3410E+ | 1.2756E− | −1.0381E− |
| | 00 | 62 | 00 | 00 | 00 | 00 | 00 | 01 | 01 |
| A10 | 1.1807E+ | 7.6545E− | −2.2905E+ | −3.1077E+ | −4.0358E+ | 4.8154E+ | 2.1843E+ | −3.6043E− | 6.4529E− |
| | 01 | 79 | 01 | 01 | 00 | 00 | 00 | 02 | 02 |
| A12 | −1.3749E+ | −5.4553E− | 8.9098E+ | 1.0024E+ | 1.909E+ | −6.0071E+ | −2.6890E+ | −2.5147E− | −2.7180E− |
| | 01 | 96 | 01 | 02 | 01 | 00 | 00 | 02 | 02 |
| A14 | −5.7787E+ | 2.4614E− | −2.1190E+ | −1.9818E+ | −1.9688E+ | 8.3961E− | 2.5590E+ | 2.1080E− | 7.4528E− |
| | 01 | 113 | 02 | 02 | 01 | 01 | 00 | 02 | 03 |
| A16 | 2.3832E+ | −6.8167E− | 3.0210E+ | 2.2941E+ | 2.0266E+ | 7.4442E+ | −1.6417E+ | −6.2965E− | −1.2705E− |
| | 02 | 131 | 02 | 02 | 01 | 00 | 00 | 03 | 03 |
| A18 | −3.3649E+ | 1.0571E− | −2.3745E+ | −1.4096E+ | −1.0400E+ | −8.6545E+ | 5.8870E− | 8.6494E− | 1.2282E− |
| | 02 | 148 | 02 | 02 | 01 | 00 | 01 | 04 | 04 |
| A20 | 1.7243E+ | −7.0267E− | 7.9178E+ | 3.4693E+ | 1.9509E+ | 3.1027E+ | −8.8058E− | −4.4431E− | −5.1946E− |
| | 02 | 167 | 01 | 01 | 00 | 00 | 02 | 05 | 06 |

The optical imaging system in this implementation satisfies the following expression.

(|SAG51|+SAG52)/CT5=0.83, where SAG51 represents a distance from an intersection of the object-side surface S9 of the fifth lens E5 and the optical axis to a projection of an edge of an optical effective area of the object-side surface S9 of the fifth lens E5 on the optical axis, SAG52 represents a distance from an intersection of the image-side surface S10 of the fifth lens E5 and the optical axis to a projection of an edge of an optical effective area of the image-side surface S10 of the fifth lens E5 on the optical axis, and CT5 represents a center thickness of the fifth lens E5 on the optical axis.

(n1+n2)/f=1.06 mm⁻¹, where n1 represents a refractive index of the first lens E1, n2 represents a refractive index of the second lens E2, and f represents a total effective focal length of the optical imaging system.

f12/f=1.10, where f12 represents an effective focal length of the cemented lens formed by the first lens and the second lens, and f represents an effective focal length of the optical imaging system. For example, f12=3.32 mm, f3.01 mm.

EPD/SD31=1.82, where EPD represents an entrance pupil diameter of the optical imaging system, and SD31 represents a maximum effective radius of the object-side surface S5 of the third lens E3;

(|f2|+|f3|)/R31=13.27, where f2 represents an effective focal length of the second lens E2, f3 represents an effective focal length of the third lens E3, and R31 represents a radius of curvature of the object-side surface S5 of the third lens E3 near the optical axis;

f/|f3|=0.18, where f represents a total effective focal length of the optical imaging system, and f3 represents an effective focal length of the third lens E3;

(f1+|f2|+|f3|)/f=12.88, where f1 represents an effective focal length of the first lens E1, f2 represents an effective focal length of the second lens E2, f3 represents an effective focal length of the third lens E3, and f represents a total effective focal length of the optical imaging system;

|R41/R51|=1.14, where R41 represents a radius of curvature of the object-side surface S7 of the fourth lens E4 near the optical axis, and R51 represents a radius of curvature of the object-side surface S9 of the fifth lens E5 at the paraxial axis;

|R41|/f4=2.19, where R41 represents a radius of curvature of the object-side surface S7 of the fourth lens E4 near the optical axis, and f4 represents an effective focal length of the fourth lens E4;

TTL=3.96 mm, where TTL represents a distance from the object-side surface S1 of the first lens E1 to the imaging surface S13 of the optical imaging system;

n1=1.545, where n1 represents a refractive index of the first lens E1, and a reference wavelength of light is 587.6 nm;

FOV=72.63°, where FOV represents a maximum angle of view of the optical imaging system.

FIG. 4A shows the spherical aberration curve of the optical imaging system of FIG. 3, which represents the deviation in focal point of light of different wavelengths after passing through the lenses. FIG. 4B shows the astigmatic field curve of the optical imaging system of FIG. 3, which represents the tangential field curvature and the sagittal field curvature. FIG. 4C shows the distortion curve of the optical imaging system of FIG. 3, which represents the magnitude of distortion corresponding to different image heights. It can be seen from FIGS. 4A to 4C that the optical imaging system of FIG. 3 can have good imaging quality.

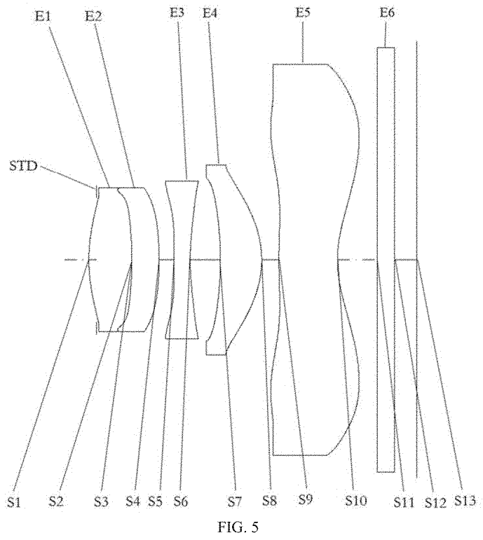

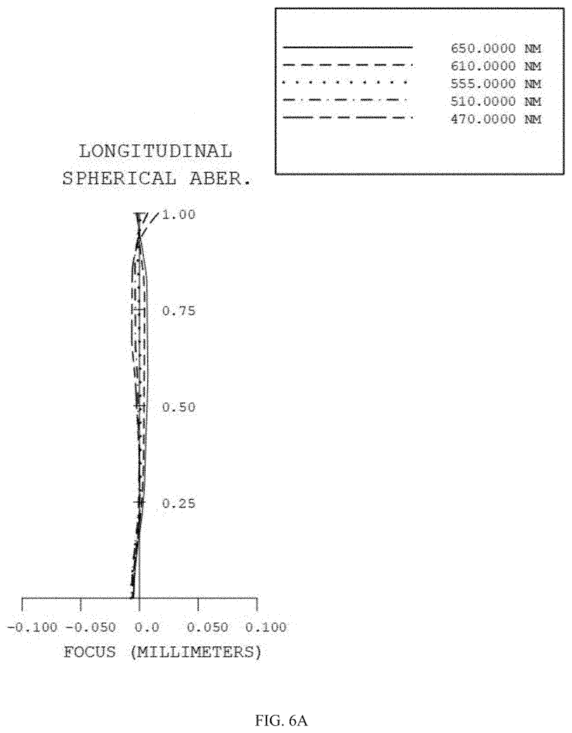

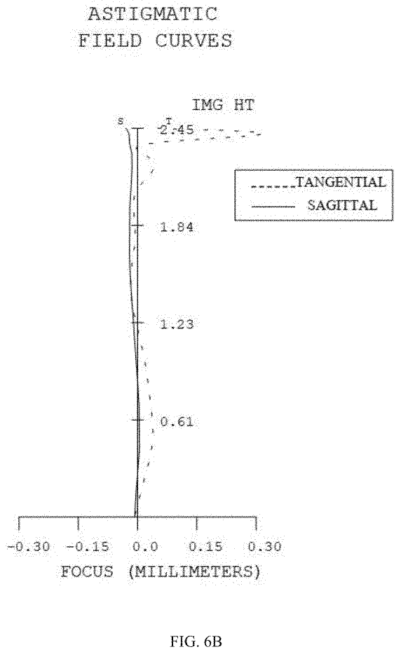

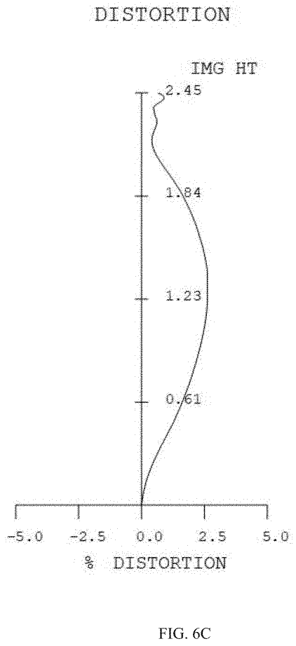

An optical imaging system according an implementation of the present disclosure will be described below with reference to FIGS. 5 to 6C. FIG. 5 shows a schematic structural diagram of the optical imaging system according to an implementation of the present disclosure.

As shown in FIG. 5, the optical imaging system includes, in order from an object side to an image side: a stop ST0, a first lens E1, a second lens E2, a third lens E3, a fourth lens E4, a fifth lens E5, a filter E6, and an imaging surface S13.

The first lens E1 has a positive refractive power and has an object-side surface S1 which is convex near an optical axis and an image-side surface S2 which is convex near the optical axis. At the periphery, the object-side surface S1 of the first lens is convex, and the image-side surface S2 is convex. The second lens E2 has a positive refractive power and has an object-side surface S3 which is concave near the optical axis and an image-side surface S4 which is convex near the optical axis. At the periphery, the object-side surface S3 of the second lens is concave, and the image-side surface S4 is convex. The third lens E3 has a negative refractive power and has an object-side surface S5 which is convex near the optical axis and an image-side surface S6 which is concave near the optical axis. At the periphery, the object-side surface S5 of the third lens is concave, and the image-side surface S6 is concave. The fourth lens E4 has a positive refractive power and has an object-side surface S7 which is concave near the optical axis and an image-side surface S8 which is convex near the optical axis. At the periphery, the object-side surface S7 of the fourth lens is concave, and the image-side surface S8 is convex. The fifth lens E5 has a negative refractive power and has an object-side surface S9 which is convex near the optical axis and an image-side surface S10 which is concave near the optical axis. At the periphery, the object-side surface S9 of the fifth lens is convex, and the image-side surface S10 is convex. The filter E6 has an object-side surface S11 and an image-side surface S12. The light from an object sequentially passes through the surfaces S1 to S12 and is finally imaged on the imaging surface S13.

In this implementation, the image-side surface S2 of the first lens E is cemented with the object-side surface S3 of the second lens E2 to form a cemented lens. Any one of the third lens E3, the fourth lens E4, and the fifth lens E5 and its adjacent lens are independent of each other and have an air gap therebetween.

Table 5 shows the surface type, radius of curvature, thickness, material, refractive index, Abbe number, and effective focal length of each lens of the optical imaging system of this implementation, where the radius of curvature, thickness, and effective focal length are all in millimeters (mm).

TABLE 5
Optical imaging system of FIG. 5
f = 2.78 mm, F_{NO} = 2.00, FOV = 78.30°, TTL = 3.86 mm

| | | | | | | | | Effective |
|---|---|---|---|---|---|---|---|---|
| Surface | | Surface | Radius of | | | Refractive | Abbe | focal |
| number | Surface name | type | curvature | Thickness | Material | index | number | length |
| OBJ | Object-side | Spherical | Infinity | 400.00 | | | | |
| | surface | | | | | | | |
| STO | Stop | Spherical | Infinity | −0.090 | | | | |
| S1 | First lens | Aspherical | 1.866 | 0.508 | Plastic | 1.545 | 55.912 | 6.80 |
| S2/S3 | Second lens | Aspherical | −3.373 | 0.320 | Plastic | 1.640 | 23.529 | 7.28 |
| S4 | | Aspherical | −3.891 | 0.179 | Plastic | 1.640 | 23.529 | 7.28 |
| S5 | Third lens | Aspherical | 45.057 | 0.195 | Plastic | 1.661 | 20.412 | −4.18 |
| S6 | | Aspherical | 2.621 | 0.356 | Plastic | | | |
| S7 | Fourth lens | Aspherical | −3.338 | 0.487 | Plastic | 1.545 | 55.912 | 2.55 |
| S8 | | Aspherical | −1.032 | 0.203 | Plastic | | | |
| S9 | Fifth lens | Aspherical | 6.895 | 0.688 | Plastic | 1.545 | 55.912 | −2.93 |
| S10 | | Aspherical | 1.253 | 0.460 | Plastic | | | |
| S11 | Infrared filter | Spherical | Infinity | 0.210 | Glass | 1.516 | 64.048 | |
| S12 | | Spherical | Infinity | 0.257 | Glass | | | |
| S13 | Imaging | Spherical | Infinity | 0 | | | | |
| | surface | | | | | | | |

Note:
The reference wavelength = 555 nm.

The effective focal length of the optical imaging system in this implementation is represented as EEL, the F-number of the optical imaging system is represented as Fₙₒ, the angle of view of the optical imaging system is represented as FOV, and the total optical length of the optical imaging system is represented as TTL, and f=2.78 mm, F_{NO}=2.00, FOV=78.3 (degrees), TTL=3.86 mm.

It can be seen from Table 5 that the object-side surface and the image-side surface of any one of the first lens E1 to the fifth lens E5 are aspherical. Table 6 below shows the conic coefficient k and the higher-order coefficients A4, A6, A8, A10, A12, A14, A16, A18, and A20 of each of aspherical lens surfaces S11 to S10 in this implementation.

TABLE 6
Optical imaging system of FIG. 5
Aspherical coefficient

| | Surface number | | | | | | | | |
|---|---|---|---|---|---|---|---|---|---|
| | 2 | 3 | 4 | 5 | 6 | 7 | 8 | 9 | 10 |
| K | 5.9312E− | −2.2361E+ | −9.7487E+ | 7.8514E+ | 2.2601E+ | 1.1747E+ | −3.9390E+ | −4.3561E+ | −3.0221E+ |
| | 01 | 01 | 01 | 01 | 00 | 01 | 00 | 00 | 00 |
| A4 | −8.8538E− | 2.3641E− | −3.4849E− | −3.8092E− | −1.8719E− | 9.3822E− | −1.9802E− | −1.5422E− | −1.6338E− |
| | 02 | 01 | 01 | 01 | 01 | 02 | 01 | 01 | 01 |
| A6 | 4.0522E− | −3.4200E+ | 9.3588E− | −3.1272E− | −5.1222E− | −2.4337E− | −7.3830E− | 2.5006E− | 8.3795E− |
| | 01 | 00 | 02 | 01 | 01 | 01 | 02 | 02 | 02 |
| A8 | −5.0617E+ | 4.2206E+ | 2.8285E+ | 3.7590E+ | 4.9076E+ | 1.5627E+ | 1.2989E+ | −8.6892E− | −1.4196E− |
| | 00 | 01 | 00 | 00 | 00 | 00 | 00 | 03 | 02 |
| A10 | 2.9439E+ | −3.3299E+ | −2.3717E+ | −1.7949E+ | −2.1323E+ | −5.8288E+ | −3.7036E+ | 9.0314E− | −1.7966E− |
| | 01 | 02 | 01 | 01 | 01 | 00 | 00 | 02 | 02 |
| A12 | −9.6459E+ | 1.5865E+ | 9.4621E+ | 5.7183E+ | 5.8267E+ | 1.2995E+ | 5.5812E+ | −1.0251E− | 1.5967E− |
| | 01 | 03 | 01 | 01 | 01 | 01 | 00 | 01 | 02 |
| A14 | 1.6420E+ | −4.6726E+ | −2.2090E+ | −1.1267E+ | −1.0091E+ | −1.7753E+ | −4.3937E+ | 5.3561E− | −6.2096E− |
| | 02 | 03 | 02 | 02 | 02 | 01 | 00 | 02 | 03 |
| A16 | −9.6589E+ | 8.2675E+ | 3.0751E+ | 1.3557E+ | 1.0745E+ | 1.4531E+ | 1.4301E+ | −1.5129E− | 1.3025E− |
| | 01 | 03 | 02 | 02 | 02 | 01 | 00 | 02 | 03 |
| A18 | −7.9863E+ | −8.0290E+ | −2.3706E+ | −9.2936E+ | −6.4178E+ | −6.5447E+ | 1.2556E− | 2.2437E− | −1.4140E− |
| | 01 | 03 | 02 | 01 | 01 | 00 | 01 | 03 | 04 |
| A20 | 9.9486E+ | 3.2764E+ | 7.7917E+ | 2.8036E+ | 1.6398E+ | 1.2496E+ | −1.3529E− | −1.3750E− | 6.1876E− |
| | 01 | 03 | 01 | 01 | 01 | 00 | 01 | 04 | 06 |

The optical imaging system in this implementation satisfies the following expression.

(|SAG51|+SAG52)/CT5=0.52, where SAG51 represents a distance from an intersection of the object-side surface S9 of the fifth lens E5 and the optical axis to a projection of an edge of an optical effective area of the object-side surface S9 of the fifth lens E5 on the optical axis, SAG52 represents a distance from an intersection of the image-side surface S10 of the fifth lens E5 and the optical axis to a projection of an edge of an optical effective area of the image-side surface S10 of the fifth lens E5 on the optical axis, and CT5 represents a center thickness of the fifth lens E5 on the optical axis.

(n1+n2)/f=1.15 mm⁻¹, where n1 represents a refractive index of the first lens E1, n2 represents a refractive index of the second lens E2, and f represents a total effective focal length of the optical imaging system.

f12/f=0.89, where f12 represents an effective focal length of the cemented lens formed by the first lens and the second lens, and f represents an effective focal length of the optical imaging system. For example, f12=2.45 mm, f=2.74 mm.

EPD/SD31=1.67, where EPD represents an entrance pupil diameter of the optical imaging system, and SD31 represents a maximum effective radius of the object-side surface S5 of the third lens E3.

(|f2|+|f3|)/R31=0.25, where f2 represents an effective focal length of the second lens E2, f3 represents an effective focal length of the third lens E3, and R31 represents a radius of curvature of the object-side surface S5 of the third lens E3 near the optical axis.

f/|f3|=0.67, where f represents a total effective focal length of the optical imaging system, and f3 represents an effective focal length of the third lens E3.

(f1+|f2|+|f3|)/f=6.35, where f1 represents an effective focal length of the first lens E1, f2 represents an effective focal length of the second lens E2, f3 represents an effective focal length of the third lens E3, and f represents a total effective focal length of the optical imaging system.

|R41/R51|=0.48, where R41 represents a radius of curvature of the object-side surface S7 of the fourth lens E4 near the optical axis, and R51 represents a radius of curvature of the object-side surface S9 of the fifth lens E5 at the paraxial axis.

|R41|/f4=1.31, where R41 represents a radius of curvature of the object-side surface S7 of the fourth lens E4 near the optical axis, and f4 represents an effective focal length of the fourth lens E4.

TTL=3.86 mm, where TTL represents a distance from the object-side surface S1 of the first lens E1 to the imaging surface S13 of the optical imaging system.

n1=1.545, where n1 represents a refractive index of the first lens E1, and a reference wavelength of light is 587.6 nm.

FOV=78.3°, where FOV represents a maximum angle of view of the optical imaging system.

FIG. 6A shows the spherical aberration curve of the optical imaging system of FIG. 5, which represents the deviation in focal point of light of different wavelengths after passing through the lenses. FIG. 6B shows the astigmatic field curve of the optical imaging system of FIG. 5, which represents the tangential field curvature and the sagittal field curvature. FIG. 6C shows the distortion curve of the optical imaging system of FIG. 5, which represents the magnitude of distortion corresponding to different image heights. It can be seen from FIGS. 6A to 6C that the optical imaging system of FIG. 5 can have good imaging quality.

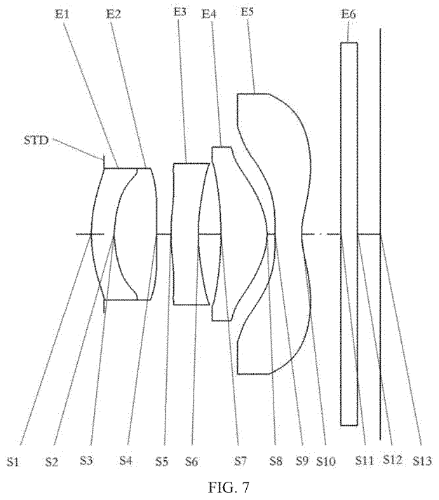

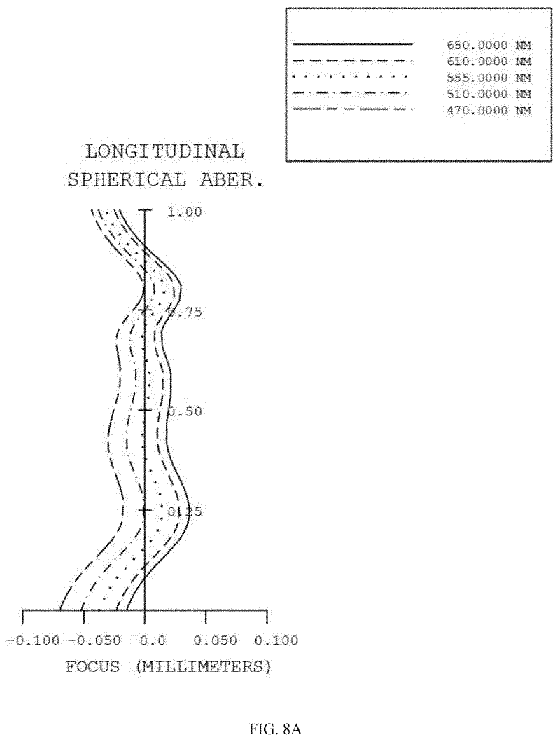

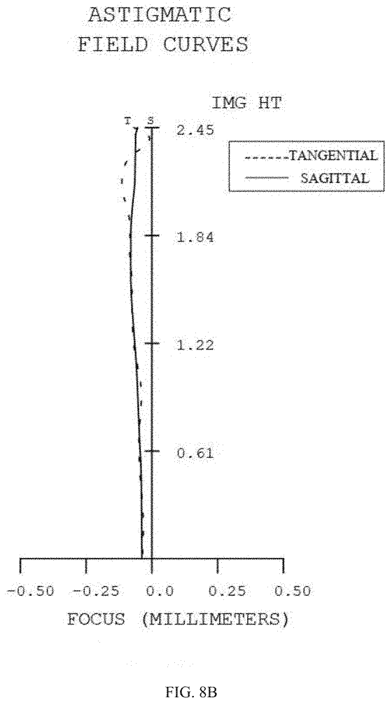

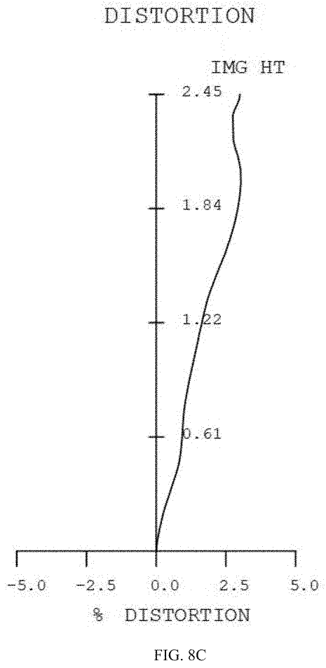

An optical imaging system according to an implementation of the present disclosure will be described below with reference to FIGS. 7 to 8C. FIG. 7 shows a schematic structural diagram of the optical imaging system according to an implementation of the present disclosure.

As shown in FIG. 7, the optical imaging system includes, in order from an object side to an image side: a stop ST0, a first lens E1, a second lens E2, a third lens E3, a fourth lens E4, a fifth lens E5, a filter E6, and an imaging surface S13.

The first lens E1 has a positive refractive power and has an object-side surface S1 which is convex near an optical axis and an image-side surface S2 which is concave near the optical axis. At the periphery, the object-side surface S1 of the first lens is convex, and the image-side surface S2 is concave. The second lens E2 has a negative refractive power and has an object-side surface S3 which is convex near the optical axis and an image-side surface S4 which is concave near the optical axis. At the periphery, the object-side surface S3 of the second lens is convex, and the image-side surface S4 is convex. The third lens E3 has a positive refractive power and has an object-side surface S5 which is convex near the optical axis and an image-side surface S6 which is concave near the optical axis. At the periphery, the object-side surface S5 of the third lens is convex, and the image-side surface S6 is concave. The fourth lens E4 has a positive refractive power and has an object-side surface S7 which is concave near the optical axis and an image-side surface S8 which is convex near the optical axis. At the periphery, the object-side surface S7 of the fourth lens is concave, and the image-side surface S8 is convex. The fifth lens E5 has a negative refractive power and has an object-side surface S9 which is concave near the optical axis and an image-side surface S10 which is concave near the optical axis. At the periphery, the object-side surface S9 of the fifth lens is concave, and the image-side surface S10 is convex. The filter E6 has an object-side surface S11 and an image-side surface S12. The light from an object sequentially passes through the surfaces S11 to S12 and is finally imaged on the imaging surface S13.

In this implementation, the image-side surface S2 of the first lens E1 is cemented with the object-side surface S3 of the second lens E2 to form a cemented lens. Any one of the third lens E3, the fourth lens E4, and the fifth lens E5 and its adjacent lens are independent of each other and have an air gap therebetween.

Table 7 shows the surface type, radius of curvature, thickness, material, refractive index, Abbe number, and effective focal length of each lens of the optical imaging system of this implementation, where the radius of curvature, thickness, and effective focal length are all in millimeters (mm)

TABLE 7
Optical imaging system of FIG. 7
f = 2.76 mm, F_{NO} = 1.78, FOV = 76.91°, TTL = 3.60 mm

| | | | | | | | | Effective |
|---|---|---|---|---|---|---|---|---|
| Surface | | | Radius of | | | Refractive | Abbe | focal |
| number | Surface name | Surface type | curvature | Thickness | Materia1 | index | number | length |
| OBJ | Object-side | Spherical | Infinity | 400.00 | | | | |
| | surface | | | | | | | |
| STO | Stop | Spherical | Infinity | −0.154 | | | | |
| S1 | First lens | Aspherical | 1.624 | 0.285 | Plastic | 1.535 | 55.796 | 4.48 |
| S2/S3 | Second lens | Aspherical | 0.599 | 0.526 | Plastic | 1.545 | 55.912 | −19.29 |
| S4 | | Aspherical | 8.097 | 0.182 | Plastic | 1.545 | 55.912 | −19.29 |
| S5 | Third lens | Aspherical | 2.163 | 0.339 | Plastic | 1.661 | 20.412 | 101.96 |
| S6 | | Aspherical | 2.094 | 0.283 | Plastic | | | |
| S7 | Fourth lens | Aspherical | −3.184 | 0.575 | Plastic | 1.545 | 55.912 | 1.55 |
| S8 | | Aspherical | −0.711 | 0.100 | Plastic | | | |
| S9 | Fifth lens | Aspherical | −12.902 | 0.330 | Plastic | 1.545 | 55.912 | −1.35 |
| S10 | | Aspherical | 0.786 | 0.487 | Plastic | | | |
| S11 | Infrared filter | Spherical | Infinity | 0.210 | Glass | 1.516 | 64.048 | |
| S12 | | Spherical | Infinity | 0.285 | Glass | | | |
| S13 | Imaging | Spherical | Infinity | 0 | | | | |
| | surface | | | | | | | |

Note:
The reference wavelength = 555 nm.

The effective focal length of the optical imaging system in this implementation is represented as EEL, the F-number of the optical imaging system is represented as Fₙₒ, the angle of view of the optical imaging system is represented as FOV, and the total optical length of the optical imaging system is represented as TTL, and f=2.76 mm, F_{NO}=1.78, FOV=76.91 (degrees), TTL=3.60 mm.

It can be seen from Table 7 that the object-side surface and the image-side surface of any one of the first lens E1 to the fifth lens E5 are aspherical. Table 8 below shows the conic coefficient k and the higher-order coefficients A4, A6, A8, A10, A12, A14, A16, A18, and A20 of each of aspherical lens surfaces S11 to S10 in this implementation.

TABLE 8
Optical imaging system of FIG. 7

| | Surface number | | | | | | | | |
|---|---|---|---|---|---|---|---|---|---|
| | 2 | 3 | 4 | 5 | 6 | 7 | 8 | 9 | 10 |
| K | 5.2993E− | −1.8457E+ | 9.7434E+ | −5.7033E+ | 2.6302E+ | 1.1777E+ | −3.9117E+ | 8.8221E+ | −8.1232E+ |
| | 01 | 01 | 00 | 00 | 00 | 01 | 00 | 01 | 00 |
| A4 | −1.0839E− | −7.3932E+ | −3.9875E− | −3.1591E− | −1.2358E− | 5.3396E− | −2.2790E− | −1.2114E+ | −5.6292E− |
| | 01 | 00 | 01 | 01 | 01 | 01 | 00 | 01 | 01 |
| A6 | 3.4892E− | 1.7448E+ | 1.0234E− | −4.3651E− | 2.6218E− | −4.6426E+ | −6.7756E− | 3.1494E+ | 1.0858E+ |
| | 01 | 02 | 01 | 01 | 01 | 00 | 01 | 00 | 00 |
| A8 | 6.1548E− | −1.8035E+ | 5.4284E+ | 4.6344E+ | −6.8657E+ | 2.9577E+ | 4.0970E+ | −7.1330E+ | −1.6005E+ |
| | 01 | 03 | 00 | 00 | 00 | 01 | 00 | 00 | 00 |
| A10 | −2.6901E+ | 1.0538E+ | −6.3208E+ | −2.8930E+ | 4.7280E+ | −1.2402E+ | −9.4461E+ | 1.2111E+ | 1.6330E+ |
| | 01 | 04 | 01 | 01 | 01 | 02 | 00 | 01 | 00 |
| A12 | 1.6606E+ | −3.7187E+ | 3.3990E+ | 1.0405E+ | −1.7611E+ | 3.3779E+ | 9.9199E+ | −1.3993E+ | −1.1172E+ |
| | 02 | 04 | 02 | 02 | 02 | 02 | 00 | 01 | 00 |
| A14 | −5.0689E+ | 8.0655E+ | −1.0096E+ | −2.1313E+ | 3.9205E+ | −5.8607E+ | −4.5293E− | 1.0631E+ | 4.9728E− |
| | 02 | 04 | 03 | 02 | 02 | 02 | 01 | 01 | 01 |
| A16 | 8.5252E+ | −1.0483E+ | 1.7045E+ | 2.5456E+ | −5.1561E+ | 6.2458E+ | −7.8285E+ | −5.0333E+ | −1.3752E− |
| | 02 | 05 | 03 | 02 | 02 | 02 | 00 | 00 | 01 |
| A18 | −7.5513E+ | 7.4600E+ | −1.5333E+ | −1.6671E+ | 3.6897E+ | −3.7205E+ | 5.9737E+ | 1.3333E+ | 2.1356E− |
| | 02 | 04 | 03 | 02 | 02 | 02 | 00 | 00 | 02 |
| A20 | 2.7546E+ | −2.2255E+ | 5.7066E+ | 4.6371E+ | −1.1056E+ | 9.4545E+ | −1.4026E+ | −1.4997E− | −1.4182E− |
| | 02 | 04 | 02 | 01 | 02 | 01 | 00 | 01 | 03 |

The optical imaging system in this implementation satisfies the following expression.

(|SAG51|+SAG52)/CT5=1.76, where SAG51 represents a distance from an intersection of the object-side surface S9 of the fifth lens E5 and the optical axis to a projection of an edge of an optical effective area of the object-side surface S9 of the fifth lens E5 on the optical axis, SAG52 represents a distance from an intersection of the image-side surface S10 of the fifth lens E5 and the optical axis to a projection of an edge of an optical effective area of the image-side surface S10 of the fifth lens E5 on the optical axis, and CT5 represents a center thickness of the fifth lens E5 on the optical axis.

(n1+n2)/f=1.12 mm⁻¹, where n1 represents a refractive index of the first lens E1, n2 represents a refractive index of the second lens E2, and f represents a total effective focal length of the optical imaging system.

f12/f=1.23, where f12 represents an effective focal length of the cemented lens formed by the first lens and the second lens, and f represents an effective focal length of the optical imaging system. For example, f12=3.54 mm, f=2.87 mm.

EPD/SD31=1.94, where EPD represents an entrance pupil diameter of the optical imaging system, and SD31 represents a maximum effective radius of the object-side surface S5 of the third lens E3.

(|f2|+|f3|)/R31=56.13, where f2 represents an effective focal length of the second lens E2, f3 represents an effective focal length of the third lens E3, and R31 represents a radius of curvature of the object-side surface S5 of the third lens E3 near the optical axis.

f/|f3|=0.03, where f represents a total effective focal length of the optical imaging system, and f3 represents an effective focal length of the third lens E3.

(f1+|f2|+|f3|)/f=45.55, where f1 represents an effective focal length of the first lens E1, f2 represents an effective focal length of the second lens E2, f3 represents an effective focal length of the third lens E3, and f represents a total effective focal length of the optical imaging system.

|R41/R51|=0.25, where R41 represents a radius of curvature of the object-side surface S7 of the fourth lens E4 near the optical axis, and R51 represents a radius of curvature of the object-side surface S9 of the fifth lens E5 at the paraxial axis.

|R41|/f4=2.05, where R41 represents a radius of curvature of the object-side surface S7 of the fourth lens E4 near the optical axis, and f4 represents an effective focal length of the fourth lens E4.

TTL=3.60 mm, where TTL represents a distance from the object-side surface S1 of the first lens E1 to the imaging surface S13 of the optical imaging system.

n1=1.535, where n1 represents a refractive index of the first lens E1, and a reference wavelength of light is 587.6 nm.

FOV=76.91°, where FOV represents a maximum angle of view of the optical imaging system.

FIG. 8A shows the spherical aberration curve of the optical imaging system of FIG. 7, which represents the deviation in focal point of light of different wavelengths after passing through the lenses. FIG. 8B shows the astigmatic field curve of the optical imaging system of FIG. 7, which represents the tangential field curvature and the sagittal field curvature. FIG. 8C shows the distortion curve of the optical imaging system of FIG. 7, which represents the magnitude of distortion corresponding to different image heights. It can be seen from FIGS. 8A to 8C that the optical imaging system of FIG. 7 can have good imaging quality.

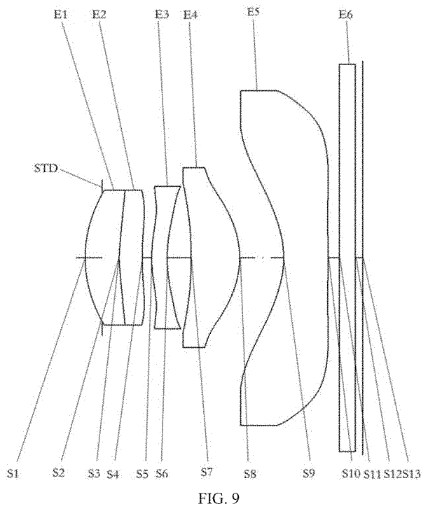

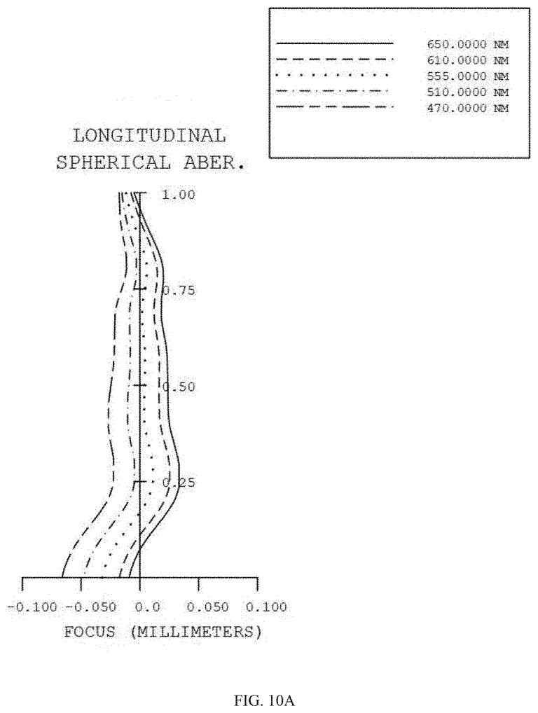

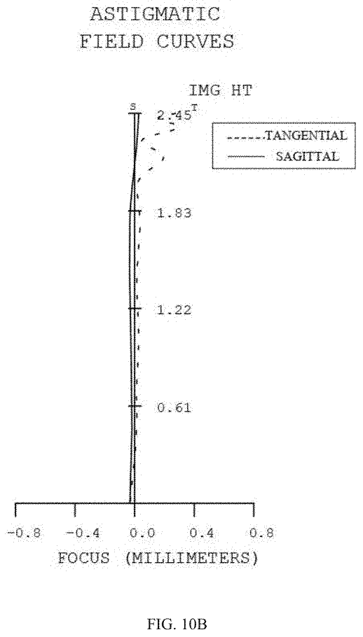

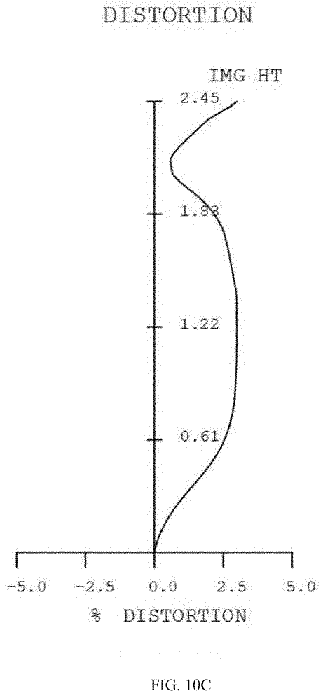

An optical imaging system according to an implementation of the present disclosure will be described below with reference to FIGS. 9 to 10C. FIG. 9 shows a schematic structural diagram of the optical imaging system according to an implementation of the present disclosure.

As shown in FIG. 9, the optical imaging system includes, in order from an object side to an image side: a stop ST0, a first lens E1, a second lens E2, a third lens E3, a fourth lens E4, a fifth lens E5, a filter E6, and an imaging surface S13.

The first lens E1 has a positive refractive power and has an object-side surface S1 which is convex near an optical axis and an image-side surface S2 which is concave near the optical axis. At the periphery, the object-side surface S1 of the first lens is convex, and the image-side surface S2 is concave. The second lens E2 has a negative refractive power and has an object-side surface S3 which is convex near the optical axis and an image-side surface S4 which is concave near the optical axis. At the periphery, the object-side surface S3 of the second lens is convex, and the image-side surface S4 is convex. The third lens E3 has a positive refractive power and has an object-side surface S5 which is convex near the optical axis and an image-side surface S6 which is concave near the optical axis. At the periphery, the object-side surface S5 of the third lens is concave, and the image-side surface S6 is concave. The fourth lens E4 has a positive refractive power and has an object-side surface S7 which is concave near the optical axis and an image-side surface S8 which is convex near the optical axis. At the periphery, the object-side surface S7 of the fourth lens is concave, and the image-side surface S8 is convex. The fifth lens E5 has a negative refractive power and has an object-side surface S9 which is concave near the optical axis and an image-side surface S10 which is convex near the optical axis. At the periphery, the object-side surface S9 of the fifth lens is concave, and the image-side surface S10 is convex. The filter E6 has an object-side surface S11 and an image-side surface S12. The light from an object sequentially passes through the surfaces S1 to S12 and is finally imaged on the imaging surface S13.

In this implementation, the image-side surface S2 of the first lens E1 is cemented with the object-side surface S3 of the second lens E2 to form a cemented lens. Any one of the third lens E3, the fourth lens E4, and the fifth lens E5 and its adjacent lens are independent of each other and have an air gap therebetween.

Table 9 shows the surface type, radius of curvature, thickness, material, refractive index, Abbe number, and effective focal length of each lens of the optical imaging system of this implementation, where the radius of curvature, thickness, and effective focal length are all in millimeters (mm).

TABLE 9
Optical imaging system of FIG. 9
f = 2.641 mm, F_{NO} = 1.64, FOV = 80.4°, TTL = 3.64 mm

| | | | | | | | | Effective |
|---|---|---|---|---|---|---|---|---|
| Surface | | Surface | Radius of | | | Refractive | Abbe | focal |
| number | Surface name | type | curvature | Thickness | Material | index | number | length |
| OBJ | Object-side | Spherical | Infinity | 400.00 | | | | |
| | surface | | | | | | | |
| STO | Stop | Spherical | Infinity | 0.223 | | | | |
| S1 | First lens | Aspherical | 1.459 | 0.446 | Plastic | 1.545 | 55.912 | 4.13 |
| S2/S3 | Second lens | Aspherical | 0.936 | 0.301 | Plastic | 1.543 | 56.052 | −5.83 |
| S4 | | Aspherical | 3.177 | 0.125 | Plastic | 1.543 | 56.052 | −5.83 |
| S5 | Third lens | Aspherical | 1.667 | 0.204 | Plastic | 1.661 | 20.412 | 21.63 |
| S6 | | Aspherical | 1.793 | 0.314 | Plastic | | | |
| S7 | Fourth lens | Aspherical | −4.397 | 0.635 | Plastic | 1.545 | 55.912 | 2.26 |
| S8 | | Aspherical | −1.014 | 0.577 | Plastic | | | |
| S9 | Fifth lens | Aspherical | −1.079 | 0.583 | Plastic | 1.545 | 55.912 | −2.61 |
| S10 | | Aspherical | −5.315 | 0.145 | Plastic | | | |
| S11 | Infrared filter | Spherical | Infinity | 0.210 | Glass | 1.516 | 64.048 | |
| S12 | | Spherical | Infinity | 0.100 | Glass | | | |
| S13 | Imaging | Spherical | Infinity | 0 | | | | |
| | surface | | | | | | | |

Note:
The reference wavelength = 555 nm.

The effective focal length of the optical imaging system in this implementation is represented as EFL, the F-number of the optical imaging system is represented as Fₙₒ, the angle of view of the optical imaging system is represented as FOV, and the total optical length of the optical imaging system is represented as TTL, and f=2.64 mm, F_{NO}=1.64, FOV=80.40 (degrees), TTL=3.64 mm.

It can be seen from Table 9 that the object-side surface and the image-side surface of any one of the first lens E1 to the fifth lens E5 are aspherical. Table 10 below shows the conic coefficient k and the higher-order coefficients A4, A6, A8, A10, A12, A14, A16, A18, and A20 of each of aspherical lens surfaces S11 to S10 in this implementation.

TABLE 10
Optical imaging system of FIG. 9

| | Surface number | | | | | | | | |
|---|---|---|---|---|---|---|---|---|---|
| | 2 | 3 | 4 | 5 | 6 | 7 | 8 | 9 | 10 |
| K | 2.0524E+ | −9.9000E+ | 5.6597E+ | −9.9000E+ | −2.2334E+ | 1.0678E+ | −6.0677E+ | −1.0062E+ | −3.0373E+ |
| | 00 | 01 | 01 | 01 | 00 | 01 | 00 | 01 | 00 |
| A4 | −8.2293E− | 2.4615E− | −5.4517E− | −5.7973E− | −1.7509E− | 2.8299E− | −3.5685E− | −1.1820E− | −2.0820E− |
| | 02 | 01 | 01 | 01 | 01 | 01 | 01 | 01 | 01 |
| A6 | 1.0104E+ | 1.5719E+ | 7.0968E− | 3.2343E− | −1.8588E− | −8.6796E− | 1.0503E+ | −1.5182E− | 2.1615E− |
| | 00 | 00 | 01 | 01 | 01 | 01 | 00 | 02 | 01 |
| A8 | −1.3550E+ | −1.5880E+ | −2.6674E+ | −1.6395E | 1.1951E+ | 3.5406E+ | −2.2602E | 1.5981E− | −1.8837E− |
| | 01 | 01 | 00 | 01 | 00 | 00 | 00 | 02 | 01 |
| A10 | 1.0173E+ | 1.0569E+ | 1.0388E+ | 6.8055E+ | −1.6109E+ | −1.1867E+ | 3.6676E+ | 4.0263E− | 1.1937E− |
| | 02 | 02 | 01 | 00 | 00 | 01 | 00 | 02 | 01 |
| A12 | 4.6663E+ | 3.8535E+ | 9.1003E+ | 2.0634E+ | 1.3790E+ | 27984E+ | 4.2646E | 5.0835E− | 5.1516E− |
| | 02 | 02 | 00 | 01 | 00 | 01 | 00 | 02 | 02 |
| A14 | 1.3215E+ | 7.8051E+ | −5.5848E+ | 1.8424E+ | 8.1321E+ | −4.2729E+ | 3.6019E+ | 2.9014E− | 1.4559E− |
| | 03 | 02 | 01 | 01 | 00 | 01 | 00 | 02 | 02 |
| A16 | −2.2707E+ | −8.8872E+ | 1.7906E+ | 1.1813E+ | −1.3582E+ | 4.0189E+ | −2.0403E+ | −9.4140E− | −2.5631E− |
| | 03 | 02 | 02 | 01 | 01 | 01 | 00 | 03 | 03 |
| A18 | 2.1660E+ | 5.3347E+ | −2.0115E+ | −2.9038E+ | 1.1149E+ | −2.1199E+ | 6.6497E− | 1.6547E− | 2.5414E− |
| | 03 | 02 | 02 | 01 | 01 | 01 | 01 | 03 | 04 |
| A20 | −8.7682E+ | −1.3139E+ | 7.9059E+ | 1.2918E+ | −3.7128E+ | 4.8005E+ | −9.2363E− | −1.2156E− | −1.0824E− |
| | 02 | 02 | 01 | 01 | 00 | 00 | 02 | 04 | 05 |

The optical imaging system in this implementation satisfies the following expression.

(|SAG51|+SAG52)/CT5=0.98, where SAG51 represents a distance from an intersection of the object-side surface S9 of the fifth lens E5 and the optical axis to a projection of an edge of an optical effective area of the object-side surface S9 of the fifth lens E5 on the optical axis, SAG52 represents a distance from an intersection of the image-side surface S10 of the fifth lens E5 and the optical axis to a projection of an edge of an optical effective area of the image-side surface S10 of the fifth lens E5 on the optical axis, and CT5 represents a center thickness of the fifth lens E5 on the optical axis.

(n1+n2)/f=1.17 mm⁻¹, where n1 represents a refractive index of the first lens E1, n2 represents a refractive index of the second lens E2, and f represents a total effective focal length of the optical imaging system.

f12/f=1.65, where f12 represents an effective focal length of the cemented lens formed by the first lens and the second lens, and f represents an effective focal length of the optical imaging system. For example, f12=4.33 mm, f2.63 mm.

EPD/SD31=1.86, where EPD represents an entrance pupil diameter of the optical imaging system, and SD31 represents a maximum effective radius of the object-side surface S5 of the third lens E3.

(|f2|+|f3|)/R31=16.44, where f2 represents an effective focal length of the second lens E2, f3 represents an effective focal length of the third lens E3, and R31 represents a radius of curvature of the object-side surface S5 of the third lens E3 near the optical axis.

f/|f3|=0.12, where f represents a total effective focal length of the optical imaging system, and f3 represents an effective focal length of the third lens E3.

(f1+|f2|+|f3|)/f=10.83, where f1 represents an effective focal length of the first lens E1, f2 represents an effective focal length of the second lens E2, f3 represents an effective focal length of the third lens E3, and f represents a total effective focal length of the optical imaging system.

|R41/R51|=4.07, where R41 represents a radius of curvature of the object-side surface S7 of the fourth lens E4 near the optical axis, and R51 represents a radius of curvature of the object-side surface S9 of the fifth lens E5 at the paraxial axis.

|R41|/f4=1.95, where R41 represents a radius of curvature of the object-side surface S7 of the fourth lens E4 near the optical axis, and f4 represents an effective focal length of the fourth lens E4.

TTL=3.64 mm, where TTL represents a distance from the object-side surface S1 of the first lens E1 to the imaging surface S13 of the optical imaging system.

n1=1.545, where n1 represents a refractive index of the first lens E1, and a reference wavelength of light is 587.6 nm.

FOV=80.4°, where FOV represents a maximum angle of view of the optical imaging system.

FIG. 10A shows the spherical aberration curve of the optical imaging system of FIG. 9, which represents the deviation in focal point of light of different wavelengths after passing through the lenses. FIG. 10B shows the astigmatic field curve of the optical imaging system of FIG. 9, which represents the tangential field curvature and the sagittal field curvature. FIG. 10C shows the distortion curve of the optical imaging system of FIG. 9, which represents the magnitude of distortion corresponding to different image heights. It can be seen from FIGS. 10A to 10C that the optical imaging system of FIG. 9 can have good imaging quality.

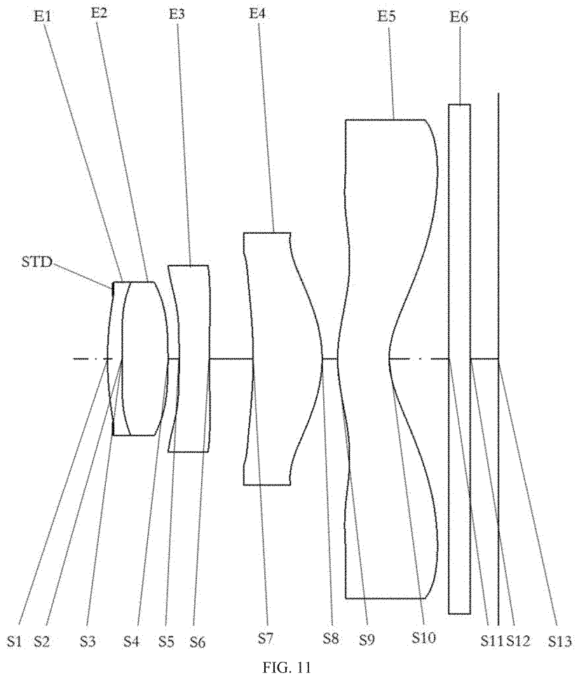

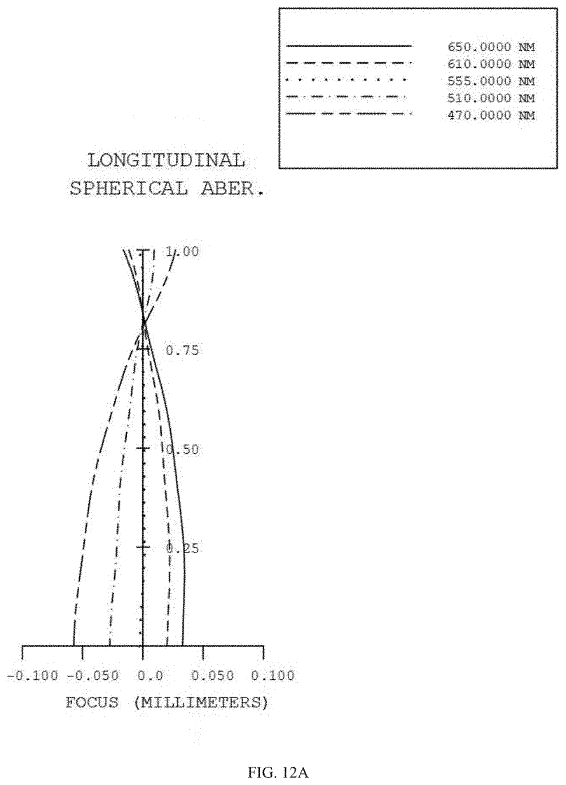

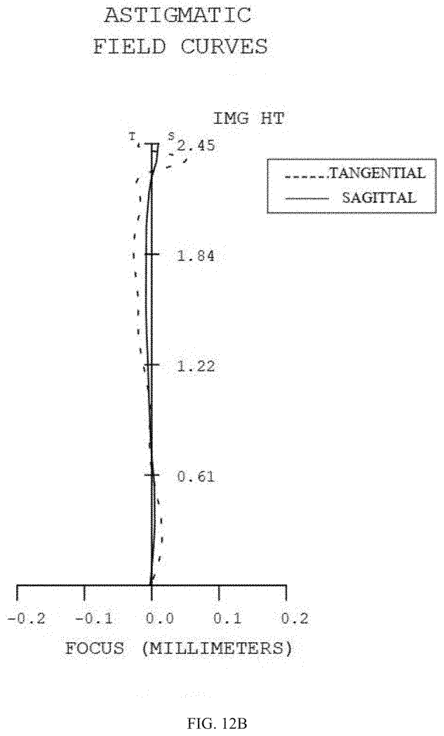

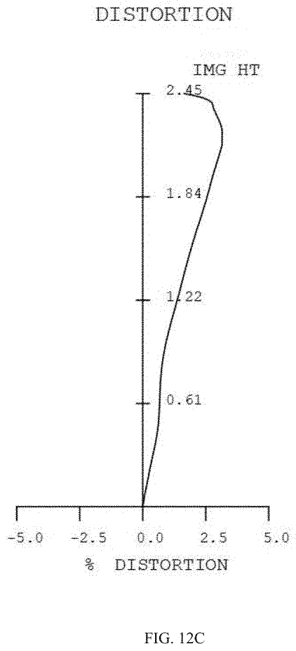

An optical imaging system according to an implementation of the present disclosure will be described below with reference to FIGS. 11 to 12C. FIG. 11 shows a schematic structural diagram of the optical imaging system according to an implementation of the present disclosure.

As shown in FIG. 11, the optical imaging system includes, in order from an object side to an image side: a stop ST0, a first lens E1, a second lens E2, a third lens E3, a fourth lens E4, a fifth lens E5, a filter E6, and an imaging surface S13.

The first lens E1 has a positive refractive power and has an object-side surface S1 which is convex near an optical axis and an image-side surface S2 which is convex near the optical axis. At the periphery, the object-side surface S1 of the first lens is convex, and the image-side surface S2 is concave. The second lens E2 has a positive refractive power and has an object-side surface S3 which is concave near the optical axis and an image-side surface S4 which is convex near the optical axis. At the periphery, the object-side surface S3 of the second lens is convex, and the image-side surface S4 is convex. The third lens E3 has a negative refractive power and has an object-side surface S5 which is convex near the optical axis and an image-side surface S6 which is concave near the optical axis. At the periphery, the object-side surface S5 of the third lens is concave, and the image-side surface S6 is convex. The fourth lens E4 has a positive refractive power and has an object-side surface S7 which is concave near the optical axis and an image-side surface S8 which is convex near the optical axis. At the periphery, the object-side surface S7 of the fourth lens is concave, and the image-side surface S8 is concave. The fifth lens E5 has a negative refractive power and has an object-side surface S9 which is convex near the optical axis and an image-side surface S10 which is concave near the optical axis. At the periphery, the object-side surface S9 of the fifth lens is convex, and the image-side surface S10 is convex. The filter E6 has an object-side surface S11 and an image-side surface S12. The light from an object sequentially passes through the surfaces S1 to S12 and is finally imaged on the imaging surface S13.

In this implementation, the image-side surface S2 of the first lens E is cemented with the object-side surface S3 of the second lens E2 to form a cemented lens. Any one of the third lens E3, the fourth lens E4, and the fifth lens E5 and its adjacent lens are independent of each other and have an air gap therebetween.

Table 11 shows the surface type, radius of curvature, thickness, material, refractive index, Abbe number, and effective focal length of each lens of the optical imaging system of this implementation, where the radius of curvature, thickness, and effective focal length are all in millimeters (mm).

TABLE 11
Optical imaging system of FIG. 11
f = 2.55 mm, F_{NO} = 2.2, FOV = 82.00°, TTL = 3.77 mm

| | | | | | | | | Effective |
|---|---|---|---|---|---|---|---|---|
| Surface | | Surface | Radius of | | | Refractive | Abbe | focal |
| number | Surface name | type | curvature | Thickness | Material | index | number | length |
| OBJ | Object-side | Spherical | Infinity | 400.00 | | | | |
| | surface | | | | | | | |
| STO | Stop | Spherical | Infinity | −0.047 | | | | |
| S1 | First lens | Aspherical | 2.789 | 0.139 | Plastic | 1.671 | 19.243 | 6.33 |
| S2/S3 | Second lens | Aspherical | −93.695 | 0.445 | Plastic | 1.545 | 55.912 | 11.94 |
| S4 | | Aspherical | −6.626 | 0.107 | Plastic | 1.545 | 55.912 | 11.94 |
| S5 | Third lens | Aspherical | 176.441 | 0.291 | Plastic | 1.661 | 20.412 | −9.93 |
| S6 | | Aspherical | 6.374 | 0.425 | Plastic | | | |
| S7 | Fourth lens | Aspherical | −3.491 | 0.664 | Plastic | 1.545 | 55.912 | 2.91 |
| S8 | | Aspherical | −1.165 | 0.150 | Plastic | | | |
| S9 | Fifth lens | Aspherical | 1.282 | 0.498 | Plastic | 1.545 | 55.912 | −3.86 |
| S10 | | Aspherical | 0.688 | 0.572 | Plastic | | | |
| S11 | Infrared filter | Spherical | Infinity | 0.210 | Glass | 1.516 | 64.048 | |
| S12 | | Spherical | Infinity | 0.270 | Glass | | | |
| S13 | Imaging | Spherical | Infinity | 0 | | | | |
| | surface | | | | | | | |

Note:
The reference wavelength = 555 nm.

The effective focal length of the optical imaging system in this implementation is represented as EEL, the F-number of the optical imaging system is represented as Fₙₒ, the angle of view of the optical imaging system is represented as FOV, and the total optical length of the optical imaging system is represented as TTL, and f2.55 mm, F_{NO}=2.2, FOV=82.00 (degrees), TTL=3.77 mm.

It can be seen from Table 11 that the object-side surface and the image-side surface of any one of the first lens E1 to the fifth lens E5 are aspherical. Table 12 below shows the conic coefficient k and the higher-order coefficients A4, A6, A8, A10, A12, A14, A16, A18, and A20 of each of aspherical lens surfaces S11 to S10 in this implementation.

TABLE 12
Optical imaging system of FIG. 11

| | Surface number | | | | | | | | |
|---|---|---|---|---|---|---|---|---|---|
| | 2 | 3 | 4 | 5 | 6 | 7 | 8 | 9 | 10 |
| K | 2.0524E+ | −9.9000E+ | 5.6597E+ | −9.9000E+ | −2.2334E+ | 1.0678E+ | −6.0677E+ | −1.0062E+ | −3.0373E+ |
| | 00 | 01 | 01 | 01 | 00 | 01 | 00 | 01 | 00 |
| A4 | −8.2293E− | 2.4615E− | −5.4517E− | −5.7973E− | −1.7509E− | 2.8299E− | −3.5685E− | −1.1820E− | −2.0820E− |
| | 02 | 01 | 01 | 01 | 01 | 01 | 01 | 01 | 01 |
| A6 | 1.0104E+ | 1.5719E+ | 7.0968E− | 3.2343E− | −1.8588E− | −8.6796E− | 1.0503E+ | −1.5182E− | 2.1615E− |
| | 00 | 00 | 01 | 01 | 01 | 01 | 00 | 02 | 01 |
| A8 | −1.3550E+ | −1.5880E+ | −2.6674E+ | −1.6395E− | 1.1951E+ | 3.5406E+ | −2.2602E+ | 1.5981E− | −1.8837E− |
| | 01 | 01 | 00 | 01 | 00 | 00 | 00 | 02 | 01 |
| A10 | 1.0173E+ | 1.0569E+ | 1.0388E+ | 6.8055E+ | −1.6109E+ | −1.1867E+ | 3.6676E+ | 4.0263E− | 1.1937E− |
| | 02 | 02 | 01 | 00 | 00 | 01 | 00 | 02 | 01 |
| A12 | −4.6663E+ | −3.8535E+ | −9.1003E+ | −2.0634E+ | −1.3790E+ | 2.7984E+ | −4.2646E+ | −5.0835E− | −5.1516E− |
| | 02 | 02 | 00 | 01 | 00 | 01 | 00 | 02 | 02 |
| A14 | 1.3215E+ | 7.8051E+ | −5.5848E+ | 1.8424E+ | 8.1321E+ | −4.2729E+ | 3.6019E+ | 2.9014E− | 1.4559E− |
| | 03 | 02 | 01 | 01 | 01 | 01 | 00 | 02 | 02 |
| A16 | −2.2707E+ | −8.8872E+ | 1.7906E+ | 1.1813E+ | −1.3582E+ | 4.0189E+ | −2.0403E+ | −9.4140E− | −2.5631E− |
| | 03 | 02 | 02 | 01 | 01 | 01 | 00 | 03 | 03 |
| A18 | 2.1660E+ | 5.3347E+ | −2.0115E+ | −2.9038E+ | 1.1149E+ | −2.1199E+ | 6.6497E− | 1.6547E− | 2.5414E− |
| | 03 | 02 | 02 | 01 | 01 | 01 | 01 | 03 | 04 |
| A20 | −8.7682E+ | −1.3139E+ | 7.9059E+ | 1.2918E+ | −3.7128E+ | 4.8005E+ | −9.2363E− | −1.2156E− | −1.0824E− |
| | 02 | 02 | 01 | 01 | 00 | 00 | 02 | 04 | 05 |

The optical imaging system in this implementation satisfies the following expression.

(|SAG51|+SAG52)/CT5=1.10, where SAG51 represents a distance from an intersection of the object-side surface S9 of the fifth lens E5 and the optical axis to a projection of an edge of an optical effective area of the object-side surface S9 of the fifth lens E5 on the optical axis, SAG52 represents a distance from an intersection of the image-side surface S10 of the fifth lens E5 and the optical axis to a projection of an edge of an optical effective area of the image-side surface S10 of the fifth lens E5 on the optical axis, and CT5 represents a center thickness of the fifth lens E5 on the optical axis.

(n1+n2)/f=1.26 mm⁻¹, where n1 represents a refractive index of the first lens E1, n2 represents a refractive index of the second lens E2, and f represents a total effective focal length of the optical imaging system.

f12/f=1.23, where f12 represents an effective focal length of the cemented lens formed by the first lens and the second lens, and f represents an effective focal length of the optical imaging system. For example, f12=3.13 mm, f2.55 mm.

EPD/SD31=1.54, where EPD represents an entrance pupil diameter of the optical imaging system, and SD31 represents a maximum effective radius of the object-side surface S5 of the third lens E3.

(|f2|+|f3|)/R31=0.12, where f2 represents an effective focal length of the second lens E2, f3 represents an effective focal length of the third lens E3, and R31 represents a radius of curvature of the object-side surface S5 of the third lens E3 near the optical axis.

f/|f3|=0.26, where f represents a total effective focal length of the optical imaging system, and f3 represents an effective focal length of the third lens E3.

(f1+|f2|+|f3|)/f=11.06, where f1 represents an effective focal length of the first lens E1, f2 represents an effective focal length of the second lens E2, f3 represents an effective focal length of the third lens E3, and f represents a total effective focal length of the optical imaging system.

|R41/R51|=2.73, where R41 represents a radius of curvature of the object-side surface S7 of the fourth lens E4 near the optical axis, and R51 represents a radius of curvature of the object-side surface S9 of the fifth lens E5 at the paraxial axis.

|R41|/f4=1.202, where R41 represents a radius of curvature of the object-side surface S7 of the fourth lens E4 near the optical axis, and f4 represents an effective focal length of the fourth lens E4.

TTL=3.77 mm, where TTL represents a distance from the object-side surface S1 of the first lens E1 to the imaging surface S13 of the optical imaging system.

n1=1.671, where n1 represents a refractive index of the first lens E1, and a reference wavelength of light is 587.6 nm.

FOV=82.00°, where FOV represents a maximum angle of view of the optical imaging system.

FIG. 12A shows the spherical aberration curve of the optical imaging system of FIG. 11, which represents the deviation in focal point of light of different wavelengths after passing through the lenses. FIG. 12B shows the astigmatic field curve of the optical imaging system of FIG. 11, which represents the tangential field curvature and the sagittal field curvature. FIG. 12C shows the distortion curve of the optical imaging system of FIG. 11, which represents the magnitude of distortion corresponding to different image heights. It can be seen from FIGS. 12A to 10C that the optical imaging system of FIG. 11 can have good imaging quality.

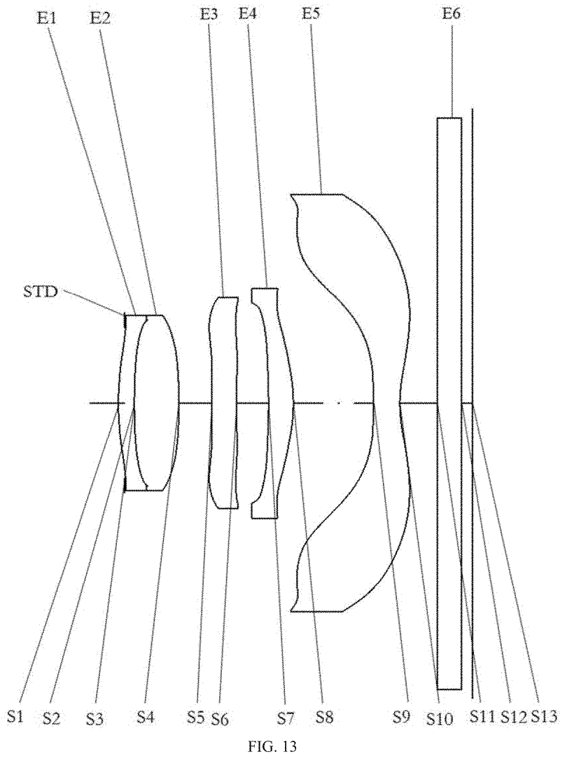

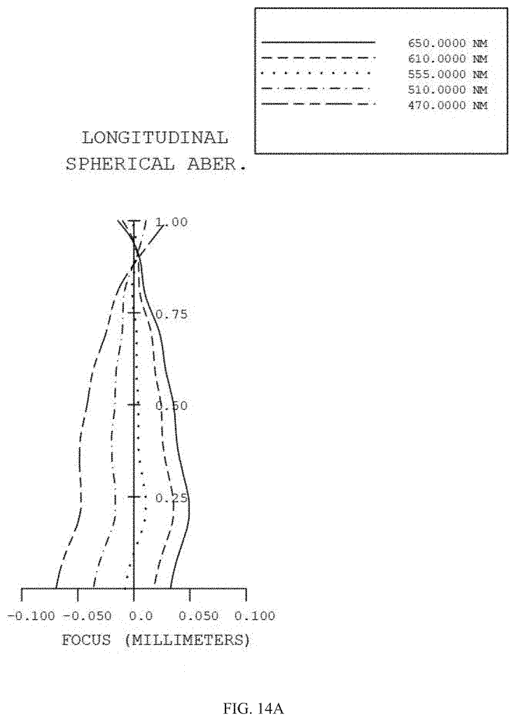

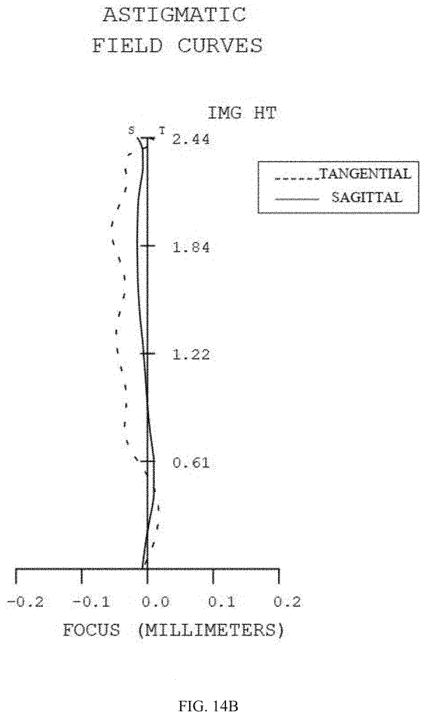

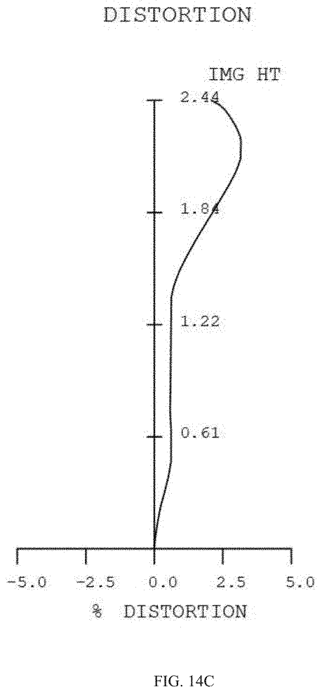

An optical imaging system according to an implementation of the present disclosure will be described below with reference to FIGS. 13 to 14C. FIG. 13 shows a schematic structural diagram of the optical imaging system according to an implementation of the present disclosure.

As shown in FIG. 13, the optical imaging system includes, in order from an object side to an image side: a stop ST0, a first lens E1, a second lens E2, a third lens E3, a fourth lens E4, a fifth lens E5, a filter E6, and an imaging surface S13.

The first lens E1 has a positive refractive power and has an object-side surface S1 which is convex near an optical axis and an image-side surface S2 which is concave near the optical axis. At the periphery, the object-side surface S1 of the first lens is convex, and the image-side surface S2 is concave. The second lens E2 has a positive refractive power and has an object-side surface S3 which is convex near the optical axis and an image-side surface S4 which is convex near the optical axis. At the periphery, the object-side surface S3 of the second lens is convex, and the image-side surface S4 is convex. The third lens E3 has a negative refractive power and has an object-side surface S5 which is convex near the optical axis and an image-side surface S6 which is concave near the optical axis. At the periphery, the object-side surface S5 of the third lens is convex, and the image-side surface S6 is concave. The fourth lens E4 has a positive refractive power and has an object-side surface S7 which is concave near the optical axis and an image-side surface S8 which is convex near the optical axis. At the periphery, the object-side surface S7 of the fourth lens is concave, and the image-side surface S8 is convex. The fifth lens E5 has a negative refractive power and has an object-side surface S9 which is concave near the optical axis and an image-side surface S10 which is concave near the optical axis. At the periphery, the object-side surface S9 of the fifth lens is concave, and the image-side surface S10 is convex. The filter E6 has an object-side surface S11 and an image-side surface S12. The light from an object sequentially passes through the surfaces S1 to S12 and is finally imaged on the imaging surface S13.

In this implementation, the image-side surface S2 of the first lens E1 is cemented with the object-side surface S3 of the second lens E2 to form a cemented lens. Any one of the third lens E3, the fourth lens E4, and the fifth lens E5 and its adjacent lens are independent of each other and have an air gap therebetween.

Table 13 shows the surface type, radius of curvature, thickness, material, refractive index, Abbe number, and effective focal length of each lens of the optical imaging system of this implementation, where the radius of curvature, thickness, and effective focal length are all in millimeters (mm).

TABLE 13
Optical imaging system of FIG. 13
f = 2.67 mm, F_{NO} = 2.15, FOV = 79.00°, TTL = 3.10 mm

| | | | | | | | | Effective |
|---|---|---|---|---|---|---|---|---|
| Surface | | Surface | Radius of | | | Refractive | Abbe | focal |
| number | Surface name | type | curvature | Thickness | Material | index | number | length |
| OBJ | Object-side | Spherical | Infinity | 400.00 | | | | |
| | surface | | | | | | | |
| STO | Stop | Spherical | Infinity | −0.054 | | | | |
| S1 | First lens | Aspherical | 2.199 | 0.140 | Plastic | 1.671 | 19.243 | 5.37 |
| S2/S3 | Second lens | Aspherical | 6.301 | 0.387 | Plastic | 1.545 | 55.912 | 19.76 |
| S4 | | Aspherical | −7.672 | 0.290 | Plastic | 1.545 | 55.912 | 19.76 |
| S5 | Third lens | Aspherical | 8.978 | 0.215 | Plastic | 1.661 | 20.412 | −17.51 |
| S6 | | Aspherical | 5.026 | 0.280 | Plastic | | | |
| S7 | Fourth lens | Aspherical | −4.277 | 0.218 | Plastic | 1.545 | 55.912 | 3.14 |
| S8 | | Aspherical | −1.246 | 0.701 | Plastic | | | |
| S9 | Fifth lens | Aspherical | −8.517 | 0.230 | Plastic | 1.545 | 55.912 | −1.62 |
| S10 | | Aspherical | 0.997 | 0.327 | Plastic | | | |
| S11 | Infrared filter | Spherical | Infinity | 0.210 | Glass | 1.516 | 64.048 | |
| S12 | | Spherical | Infinity | 0.100 | Glass | | | |
| S13 | Imaging | Spherical | Infinity | 0 | | | | |
| | surface | | | | | | | |

Note:
The reference wavelength = 555 nm.

The effective focal length of the optical imaging system in this implementation is represented as EFL, the F-number of the optical imaging system is represented as Fₙₒ, the angle of view of the optical imaging system is represented as FOV, and the total optical length of the optical imaging system is represented as TTL, and f=2.67 mm, F_{NO}=2.15, FOV=79.00 (degrees), TTL=3.10 mm.

It can be seen from Table 13 that the object-side surface and the image-side surface of any one of the first lens E1 to the fifth lens E5 are aspherical. Table 14 below shows the conic coefficient k and the higher-order coefficients A4, A6, A8, A10, A12, A14, A16, A18, and A20 of each of aspherical lens surfaces S11 to S10 in this implementation.

TABLE 14
Optical imaging system of FIG. 13
Aspherical coefficient

| | Surface number | | | | | | | | |
|---|---|---|---|---|---|---|---|---|---|
| | 2 | 3 | 4 | 5 | 6 | 7 | 8 | 9 | 10 |
| K | −2.9367E+ | 8.1608E+ | 6.3589E+ | 9.2374E+ | 1.633E+ | 1.6405E+ | −1.5913E | 1.9018E+ | −8.9651E+ |
| | 00 | 01 | 01 | 01 | 00 | 01 | 01 | 01 | 00 |
| A4 | −1.5356E− | 5.0202E− | −4.4311E− | −4.3326E− | −1.7790E− | 4.3622E− | −3.5987E− | −1.1715E+ | −5.5017E− |
| | 01 | 01 | 01 | 01 | 01 | 00 | 01 | 00 | 01 |
| A6 | 2.9039E+ | −9.2995E+ | 1.4348E+ | −2.0132E | −2.8554E | 2.2439E+ | 4.0549E+ | 2.5885E+ | 9.8654E− |
| | 00 | 00 | 00 | 00 | 00 | 00 | 00 | 00 | 01 |
| A8 | −5.7039E+ | 1.0221E+ | −1.9000E+ | 1.4817E+ | 1.5361E+ | −4.4628E+ | −2.6900E+ | −4.6730E+ | −1.2959E+ |
| | 01 | 02 | 01 | 01 | 01 | 01 | 01 | 00 | 00 |
| A10 | 5.8528E+ | −6.2088E+ | 1.5777E+ | −5.2265E+ | −4.6168E+ | 2.9092E+ | 1.1555E+ | 5.1078E+ | 1.0717E+ |
| | 02 | 02 | 02 | 01 | 01 | 02 | 02 | 00 | 00 |
| A12 | −3.5676E+ | 2.2390E+ | −7.9245E+ | 1.5110E+ | 9.3719E+ | −1.1094E+ | −3.3671E+ | −3.1346E+ | −5.4568E− |
| | 03 | 03 | 02 | 02 | 01 | 03 | 02 | 00 | 01 |
| A14 | 1.3288E+ | −4.6398E+ | 2.4524E+ | −3.0324E+ | −9.9296E+ | 2.6061E+ | 6.3720E+ | 1.0680E+ | 1.6433E− |
| | 04 | 03 | 03 | 02 | 01 | 03 | 02 | 00 | 01 |
| A16 | −2.9696E+ | 4.6566E+ | −4.5503E+ | 3.6170E+ | 1.6560E+ | −3.6752E+ | −7.2674E+ | −1.8547E− | −2.5688E− |
| | 04 | 03 | 03 | 02 | 10 | 03 | 02 | 01 | 02 |
| A18 | 3.6545E+ | −7.0088E+ | 4.6300E+ | −2.2816E+ | 5.2520E+ | 2.8553E+ | 4.4849E+ | 1.1301E− | 1.1515E− |
| | 04 | 02 | 03 | 02 | 01 | 03 | 02 | 02 | 03 |
| A20 | −1.9020E+ | −1.4929E+ | −1.9890E+ | 5.8556E+ | −2.9944E+ | −9.4407E+ | −1.1459E+ | 3.6008E− | 1.0402E− |
| | 04 | 03 | 03 | 01 | 01 | 02 | 02 | 04 | 04 |

The optical imaging system in this implementation satisfies the following expression.

(|SAG51|+SAG52)/CT5=3.26, where SAG51 represents a distance from an intersection of the object-side surface S9 of the fifth lens E5 and the optical axis to a projection of an edge of an optical effective area of the object-side surface S9 of the fifth lens E5 on the optical axis, SAG52 represents a distance from an intersection of the image-side surface S10 of the fifth lens E5 and the optical axis to a projection of an edge of an optical effective area of the image-side surface S10 of the fifth lens E5 on the optical axis, and CT5 represents a center thickness of the fifth lens E5 on the optical axis.

(n1+n2)/f=1.20 mm⁻¹, where n1 represents a refractive index of the first lens E1, n2 represents a refractive index of the second lens E2, and f represents a total effective focal length of the optical imaging system.

f12/f=1.06, where f12 represents an effective focal length of the cemented lens formed by the first lens and the second lens, and f represents an effective focal length of the optical imaging system. For example, f12=2.84 mm, f=2.67 mm.

EPD/SD31=1.43, where EPD represents an entrance pupil diameter of the optical imaging system, and SD31 represents a maximum effective radius of the object-side surface S5 of the third lens E3.

(|f2|+|f3|)/R31=4.15, where f2 represents an effective focal length of the second lens E2, f3 represents an effective focal length of the third lens E3, and R31 represents a radius of curvature of the object-side surface S5 of the third lens E3 near the optical axis.

f/|f3|=0.15, where f represents a total effective focal length of the optical imaging system, and f3 represents an effective focal length of the third lens E3.

(f1+|f2|+|f3|)/f=15.97, where f1 represents an effective focal length of the first lens E1, f2 represents an effective focal length of the second lens E2, f3 represents an effective focal length of the third lens E3, and f represents a total effective focal length of the optical imaging system.

|R41/R51|=0.50, where R41 represents a radius of curvature of the object-side surface S7 of the fourth lens E4 near the optical axis, and R51 represents a radius of curvature of the object-side surface S9 of the fifth lens E5 at the paraxial axis.

|R41|/f4=1.36, where R41 represents a radius of curvature of the object-side surface S7 of the fourth lens E4 near the optical axis, and f4 represents an effective focal length of the fourth lens E4.

TTL=3.10 mm, where TTL represents a distance from the object-side surface S1 of the first lens E1 to the imaging surface S13 of the optical imaging system.

n1=1.671, where n1 represents a refractive index of the first lens E1, and a reference wavelength of light is 587.6 nm.

FOV=79.00°, where FOV represents a maximum angle of view of the optical imaging system.

FIG. 14A shows the spherical aberration curve of the optical imaging system of FIG. 13, which represents the deviation in focal point of light of different wavelengths after passing through the lenses. FIG. 14B shows the astigmatic field curve of the optical imaging system of FIG. 13, which represents the tangential field curvature and the sagittal field curvature. FIG. 14C shows the distortion curve of the optical imaging system of FIG. 13, which represents the magnitude of distortion corresponding to different image heights. It can be seen from FIGS. 14A to 14C that the optical imaging system of FIG. 13 can have good imaging quality.

The above are only specific implementations of the present disclosure, but the scope of protection of this disclosure is not limited to this. Any person skilled in the art can easily think of various equivalent modifications or replacements within the technical scope disclosed in this disclosure. These modifications or replacements shall be covered within the scope of protection of this disclosure. Therefore, the protection scope of this disclosure shall be subject to the protection scope of the claims.

What is claimed is:

1. An optical imaging system comprising, in order from an object side to an image side along an optical axis:
a first lens with a positive refractive power, wherein the first lens has an object-side surface which is convex near the optical axis;
a second lens with a refractive power, wherein the first lens and the second lens are cemented to form a cemented lens;
a third lens with a refractive power, wherein the third lens has an object-side surface which is convex near the optical axis and an image-side surface which is concave near the optical axis;
a fourth lens with a positive refractive power, wherein the fourth lens has an object-side surface which is concave near the optical axis and an image-side surface which is convex near the optical axis; and
a fifth lens with a refractive power, wherein the fifth lens has an object-side surface and an image-side surface which are aspherical, at least one of the object-side surface and the image-side surface of the fifth lens has at least one inflection point, and the optical system satisfies the following expression:
0.5<(|SAG51|+SAG52)/CT5<3.5;
wherein SAG51 represents a distance from an intersection of the object-side surface of the fifth lens and the optical axis to a projection of an edge of an optical effective area of the object-side surface of the fifth lens on the optical axis, SAG52 represents a distance from an intersection of the image-side surface of the fifth lens and the optical axis to a projection of an edge of an optical effective area of the image-side surface of the fifth lens on the optical axis, and CT5 represents a center thickness of the fifth lens on the optical axis.

2. The optical imaging system of claim 1, wherein the optical imaging system satisfies the following expression:
1.0 mm⁻¹<(n1+n2)/f≤1.3 mm⁻¹;
wherein n1 represents a refractive index of the first lens, n2 represents a refractive index of the second lens, f represents an effective focal length of the optical imaging system, and a reference wavelength of light is 587.6 nm.

3. The optical imaging system of claim 1, wherein the optical imaging system satisfies the following expression:
0.8<f12/f<1.7;
wherein f12 represents an effective focal length of the cemented lens formed by the first lens and the second lens, and f represents an effective focal length of the optical imaging system.

4. The optical imaging system of claim 1, wherein the optical imaging system satisfies the following expression:
1.4<EPD/SD31<2.0;
wherein EPD represents an entrance pupil diameter of the optical imaging system, and SD31 represents a maximum effective radius of the object-side surface of the third lens.

5. The optical imaging system of claim 1, wherein the optical imaging system satisfies the following expression:
(|f2|+|f3|)/R31<57.0;
wherein f2 represents an effective focal length of the second lens, f3 represents an effective focal length of the third lens, and R31 represents a radius of curvature of the object-side surface of the third lens near the optical axis.

6. The optical imaging system of claim 1, wherein the optical imaging system satisfies the following expression:
f/|f3|<0.70;
wherein f represents an effective focal length of the optical imaging system, and f3 represents an effective focal length of the third lens.

7. The optical imaging system of claim 1, wherein the optical imaging system satisfies the following expression:
6<(f1+|f2|+|f3|)/f<46.0;
wherein f1 represents an effective focal length of the first lens, f2 represents an effective focal length of the second lens, f3 represents an effective focal length of the third lens, and f represents an effective focal length of the optical imaging system.

8. The optical imaging system of claim 1, wherein the optical imaging system satisfies the following expression:

|R41/R51|<4.0;
wherein R41 represents a radius of curvature of the object-side surface of the fourth lens near the optical axis, and R51 represents a radius of curvature of the object-side surface of the fifth lens near the optical axis.

9. The optical imaging system of claim 1, wherein the optical imaging system satisfies the following expression:
1.2≤|R41|/f4<2.9;
wherein R41 represents a radius of curvature of the object-side surface of the fourth lens near the optical axis, and f4 represents an effective focal length of the fourth lens.

10. The optical imaging system of claim 1, wherein the optical imaging system satisfies the following expression:
3.0<TTL<4.0;
wherein the optical imaging system has an imaging surface on the image side, and TTL represents a distance from the object-side surface of the first lens to the imaging surface of the optical imaging system.

11. The optical imaging system of claim 1, wherein the optical imaging system satisfies the following expression:
n1>1.535;
wherein n1 represents a refractive index of the first lens, and a reference wavelength of light is 587.6 nm.

12. The optical imaging system of claim 1, wherein the optical imaging system satisfies the following expression:
70°≤FOV≤85°;
wherein FOV represents a maximum angle of view of the optical imaging system.

13. A lens, comprising:
an optical imaging system comprising, in order from an object side to an image side along an optical axis:
a first lens with a positive refractive power, wherein the first lens has an object-side surface which is convex near the optical axis;
a second lens with a refractive power, wherein the first lens and the second lens are cemented to form a cemented lens;
a third lens with a refractive power, wherein the third lens has an object-side surface which is convex near the optical axis and an image-side surface which is concave near the optical axis;
a fourth lens with a positive refractive power, wherein the fourth lens has an object-side surface which is concave near the optical axis and an image-side surface which is convex near the optical axis; and
a fifth lens with a refractive power, wherein the fifth lens has an object-side surface and an image-side surface which are aspherical, at least one of the object-side surface and the image-side surface of the fifth lens has at least one inflection point, and the optical system satisfies the following expression:
0.5<(|SAG51|+SAG52)/CT5<3.5;
wherein SAG51 represents a distance from an intersection of the object-side surface of the fifth lens and the optical axis to a projection of an edge of an optical effective area of the object-side surface of the fifth lens on the optical axis, SAG52 represents a distance from an intersection of the image-side surface of the fifth lens and the optical axis to a projection of an edge of an optical effective area of the image-side surface of the fifth lens on the optical axis, and CT5 represents a center thickness of the fifth lens on the optical axis; and
a photosensitive element disposed on the image side of the optical imaging system.

14. The lens of claim 13, wherein the optical imaging system satisfies the following expression:
1.0 mm⁻¹<(n1+n2)/f≤1.3 mm⁻¹;
wherein n1 represents a refractive index of the first lens, n2 represents a refractive index of the second lens, f represents an effective focal length of the optical imaging system, and a reference wavelength of light is 587.6 nm.

15. The lens of claim 13, wherein the optical imaging system satisfies the following expression:
0.8<f12/f<1.7;
wherein f12 represents an effective focal length of the cemented lens formed by the first lens and the second lens, and f represents an effective focal length of the optical imaging system.

16. The lens of claim 13, wherein the optical imaging system satisfies the following expression:
1.4<EPD/SD31<2.0;
wherein EPD represents an entrance pupil diameter of the optical imaging system, and SD31 represents a maximum effective radius of the object-side surface of the third lens.

17. The lens of claim 13, wherein the optical imaging system satisfies the following expression:
(|f2|+|f3|)/R31<57.0;
wherein f2 represents an effective focal length of the second lens, f3 represents an effective focal length of the third lens, and R31 represents a radius of curvature of the object-side surface of the third lens near the optical axis.

18. The lens of claim 13, wherein the optical imaging system satisfies the following expression:
f/|f3|<0.70;
wherein f represents an effective focal length of the optical imaging system, and f3 represents an effective focal length of the third lens.

19. The lens of claim 13, wherein the optical imaging system satisfies the following expression:
6<(f1+|f2|+|f3|)/f<46.0;
wherein f1 represents an effective focal length of the first lens, f2 represents an effective focal length of the second lens, f3 represents an effective focal length of the third lens, and f represents an effective focal length of the optical imaging system.

20. An electronic device, comprising:
a main body; and
a lens installed on the main body, wherein the lens comprises:
an optical imaging system comprising, in order from an object side to an image side along an optical axis:
a first lens with a positive refractive power, wherein the first lens has an object-side surface which is convex near the optical axis;
a second lens with a refractive power, wherein the first lens and the second lens are cemented to form a cemented lens;
a third lens with a refractive power, wherein the third lens has an object-side surface which is convex near the optical axis and an image-side surface which is concave near the optical axis;
a fourth lens with a positive refractive power, wherein the fourth lens has an object-side surface which is concave near the optical axis and an image-side surface which is convex near the optical axis; and
a fifth lens with a refractive power, wherein the fifth lens has an object-side surface and an image-side surface which are aspherical, at least one of the object-side surface and the image-side surface of the fifth lens has at least one inflection point, and the optical system satisfies the following expression:
0.5<(|SAG51|+SAG52)/CT5<3.5;
wherein SAG51 represents a distance from an intersection of the object-side surface of the fifth lens and the optical axis to a projection of an edge of an optical effective area of the object-side surface of the fifth lens on the optical axis, SAG52 represents a distance from an intersection of the image-side surface of the fifth lens and the optical axis to a projection of an edge of an optical effective area of the image-side surface of the fifth lens on the optical axis, and CT5 represents a center thickness of the fifth lens on the optical axis; and
a photosensitive element disposed on the image side of the optical imaging system.
